(19) United States
(12) Patent Application Publication
(10) Pub. No.: US 2016/0049674 A1
(43) Pub. Date: Feb. 18, 2016

(54) FUEL CELL STACK, FUEL CELL STACK COMPOSITE, AND FUEL CELL SYSTEM

(71) Applicants: Tomohisa YOSHIE, Osaka-shi (JP); Masashi MURAOKA, Osaka-shi (JP); Takenori ONISHI, Osaka-shi (JP); Hirotaka MIZUHATA, Osaka-shi (JP); Mutsuko KOMODA, Osaka-shi (JP); Shinobu TAKENAKA, Osaka-shi (JP)

(72) Inventors: Tomohisa YOSHIE, Osaka-shi (JP); Masashi MURAOKA, Osaka-shi (JP); Takenori ONISHI, Osaka-shi (JP); Hirotaka MIZUHATA, Osaka-shi (JP); Mutsuko KOMODA, Osaka-shi (JP); Shinobu TAKENAKA, Osaka-shi (JP)

(73) Assignee: SHARP KABUSHIKI KAISHA, Osaka (JP)

(21) Appl. No.: 13/603,898

(22) Filed: Sep. 5, 2012

(30) Foreign Application Priority Data
Sep. 8, 2011 (JP) 2011-195652
Sep. 8, 2011 (JP) 2011-195653

(51) Int. Cl. H01M 8/04; H01M 8/10

(52) U.S. Cl. CPC H01M 8/04201; H01M 8/1004; H01M 2250/30

(57) ABSTRACT

Provided is a fuel cell stack, comprising: a first fuel cell including a first membrane electrode assembly, and a first fuel supply portion having a first in-cell fuel flow channel; a second fuel cell arranged on a main surface of the first fuel cell, and including a second membrane electrode assembly and a second fuel supply portion having a second in-cell fuel flow channel; and a fuel distribution portion including a liquid fuel inlet, a main flow channel connected thereto, and first and second branched flow channels connecting an end of the main flow channel with the first and second in-cell fuel flow channels, respectively, wherein a total length of the first branched flow channel and the first in-cell fuel flow channel is substantially identical to that of the second branched flow channel and the second in-cell fuel flow channel. Also provided is a fuel cell system using the stack.

### BACKGROUND OF THE INVENTION

1. Field of the Invention

The present invention relates to a fuel cell stack in which a plurality of fuel cells are stacked thickness-wise, a fuel cell stack composite in which a plurality of fuel cell stacks are stacked thickness-wise, and a fuel cell system containing the fuel cell stack or the fuel cell stack composite.

2. Description of the Background Art

It is increasingly expected to bring fuel batteries into practice as novel power sources for portable electronics that support the information society. Fuel batteries are classified into phosphoric acid type, fused carbonate type, solid electrolyte type, polymer electrolyte type, direct alcohol type and so on according to the classification of the electrolyte material or fuel being used. In particular, practical realization as a miniature fuel battery intended for application to portable electronics is considered for a polymer electrolyte type fuel battery and a direct alcohol type fuel battery containing an ion exchange membrane which is a solid polymer as an electrolyte material because high power generation efficiency is obtained by these at normal temperature.

A direct alcohol type fuel battery in which alcohol or an alcohol aqueous solution is used as fuel (for example, see Japanese Patent Laying-Open No. 2008-235243) is able to simplify the fuel battery structure and save the space because a fuel tank can be designed relatively easily in comparison with the case where gas is used as fuel, and is highly expected, in particular, as a miniature fuel battery intended for application to portable electronics.

### SUMMARY OF THE INVENTION

In a fuel battery, it is conventionally conducted to electrically connect and combine a plurality of fuel cells for increasing an insufficient electronic power generated by a single fuel cell, for example, to an extent sufficient as a novel power source for portable electronics. In this case, it is important to be able to supply fuel uniformly to each fuel cell. If supply of fuel to each fuel cell is not uniform, a fuel cell that is unable to exert sufficient output due to shortage of fuel arises, leading deterioration in output as the whole fuel battery.

Such a problem of nonuniformity of fuel supply is particularly significant in a fuel battery wherein another fuel cell is stacked on a main surface of a fuel cell, namely, a plurality of fuel cells are stacked thickness-wise (such a fuel battery is referred to as “fuel cell stack” in the present description) whose supply of liquid fuel via a flow channel is susceptible to the gravity when the liquid fuel is supplied to each fuel cell via the flow channel.

In the aforementioned Japanese Patent Laying-Open No. 2008-235243, invention for solving the technical problem of uniformizing supply of fuel to a fuel cell is described, however, this document discloses uniformization of fuel supply within an anode electrode plane in one fuel cell, but lacks teaching about uniformization of fuel supply to plural fuel cells, and thus teaching about uniformization of fuel supply to plural fuel cells stacked thickness-wise.

Therefore, it is an object of the present invention to provide a fuel cell stack including a plurality of fuel cells stacked thickness-wise and a fuel cell stack composite including a plurality of fuel cell stacks stacked thickness-wise capable of supplying liquid fuel uniformly to each fuel cell, and a fuel cell system containing the fuel cell stack or the fuel cell stack assembly.

The present invention includes the followings.

[1] A fuel cell stack including:

a first fuel cell including a first membrane electrode assembly having a first anode electrode, a first electrolyte membrane and a first cathode electrode in this order, and a first fuel supply portion arranged on the side of the first anode electrode and having a first in-cell fuel flow channel for allowing liquid fuel to communicate;

a second fuel cell arranged on a main surface of the first fuel cell, the second fuel cell including a second membrane electrode assembly having a second anode electrode, a second electrolyte membrane and a second cathode electrode in this order, and a second fuel supply portion arranged on the side of the second anode electrode and having a second in-cell fuel flow channel for allowing liquid fuel to communicate, and

a fuel distribution portion connected to the first and second fuel cells, for distributing the liquid fuel into the first and second fuel cells,

the fuel distribution portion including:

an inlet for introducing the liquid fuel, and

an out-cell fuel flow channel including a main flow channel connected to the inlet, a first branched flow channel connecting an end on the side opposite to the inlet in the main flow channel and the first in-cell fuel flow channel, and a second branched flow channel connecting the end and the second in-cell fuel flow channel,

wherein a total length of the first branched flow channel and the first in-cell fuel flow channel is substantially identical to a total length of the second branched flow channel and the second in-cell fuel flow channel.

[2] The fuel cell stack according to [1], wherein the first and second branched flow channels include a flow channel part extending substantially perpendicularly to a main surface of the first or second fuel cell.

[3] The fuel cell stack according to [1] or [2], wherein the first branched flow channel and the first in-cell fuel flow channel form, in their connection part, a flow channel that extends substantially perpendicularly to a main surface of the first fuel cell, and the second branched flow channel and the second in-cell fuel flow channel form, in their connection part, a flow channel that extends substantially perpendicularly to a main surface of the second fuel cell.

[4] The fuel cell stack according to [1] or [2], wherein the first branched flow channel and the first in-cell fuel flow channel form, in their connection part, a flow channel that extends substantially parallel with a main surface of the first fuel cell, and the second branched flow channel and the second in-cell fuel flow channel form, in their connection part, a flow channel that extends substantially parallel with a main surface of the second fuel cell.

[5] The fuel cell stack according to any one of [1] to [4], wherein each of section areas of the first in-cell fuel flow channel, the second in-cell fuel flow channel and the out-cell fuel flow channel falls within the range of 100 μm² to 1 mm².

[6] The fuel cell stack according to any one of [1] to [5], wherein the first fuel cell and the second fuel cell are arranged at a distance so that the side of the first cathode electrode faces the side of the second cathode electrode.

[7] The fuel cell stack according to any one of [1] to [5], wherein the first fuel cell and the second fuel cell are arranged at a distance so that the side of the first cathode electrode faces the side of the second fuel supply portion, or the side of the second cathode electrode faces the side of the first fuel supply portion.

[8] The fuel cell stack according to any one of [1] to [7], including:

a first fuel cell assembly including two or more the first fuel cells arranged on the same plane,

a second fuel cell assembly arranged on a main surface of the first fuel cell assembly, the second fuel cell assembly including two or more second fuel cells arranged on the same plane and arranged to face respective the first fuel cells, and

the fuel distribution portion connected to every first and second fuel cell,

wherein at least regarding first fuel cell and second fuel cell facing each other, a total length of the first branched flow channel and the first in-cell fuel flow channel is substantially identical to a total length of the second branched flow channel and the second in-cell fuel flow channel.

[9] The fuel cell stack according to [8], wherein the first fuel cell assembly includes two or more first fuel cells arranged in line, and the second fuel cell assembly includes two or more second fuel cells arranged in line.

[10] The fuel cell stack according to [9], wherein in the first fuel cell assembly, two or more first fuel cells are arranged so that a gap is formed between neighboring two first fuel cells, and in the second fuel cell assembly, two or more second fuel cells are arranged so that a gap is formed between neighboring two second fuel cells.

[11] The fuel cell stack according to [9], wherein the first fuel cell assembly includes two or more first fuel cells arranged in line without any gap, and the second fuel cell assembly includes two or more second fuel cells arranged in line without any gap.

[12] The fuel cell stack according to any one of [1] to [11], which is a direct alcohol type fuel battery.

[13] A fuel cell system including:

a fuel cell stack according to any one of [1] to [12]; and

a fuel tank connected to the inlet, for accommodating the liquid fuel.

[14] The fuel cell system according to [13], further including a liquid sending means for promoting flow of the liquid fuel to the inlet from the fuel tank.

[15] A fuel cell stack including:

a first fuel cell including a first membrane electrode assembly having a first anode electrode, a first electrolyte membrane and a first cathode electrode in this order, and a first fuel supply portion arranged on the side of the first anode electrode and having a first in-cell fuel flow channel for allowing liquid fuel to communicate;

a second fuel cell arranged on a main surface of the first fuel cell, the second fuel cell including a second membrane electrode assembly having a second anode electrode, a second electrolyte membrane and a second cathode electrode in this order, and a second fuel supply portion arranged on the side of the second anode electrode and having a second in-cell fuel flow channel for allowing liquid fuel to communicate, and

a fuel distribution portion connected to the first and second fuel cells, for distributing the liquid fuel into the first and second fuel cells,

the fuel distribution portion having an inlet for introducing the liquid fuel, and an out-cell fuel flow channel connecting the inlet and the first and second in-cell fuel flow channels,

wherein a fuel flow channel composed of the first and second in-cell fuel flow channels and the out-cell fuel flow channel is so configured that pressure loss of the liquid fuel flowing into the first and second in-cell fuel flow channels from the inlet through the out-cell fuel flow channel increases at or in the vicinity of a connection part of the first and second in-cell fuel flow channels and the out-cell fuel flow channel.

[16] The fuel cell stack according to [15], wherein at least at or in the vicinity of the connection part between the first and second in-cell fuel flow channels and the out-cell fuel flow channel, a section area of a fuel flow channel part on the side of the inlet based on the connection part or the vicinity thereof is larger than a section area of the remaining fuel flow channel part.

[17] The fuel cell stack according to [16], wherein at least at the connection part between the first and second in-cell fuel flow channels and the out-cell fuel flow channel, a section area of the out-cell fuel flow channel is larger than section areas of the first and second in-cell fuel flow channels.

[18] The fuel cell stack according to [16] or [17], wherein a porous body is charged in the fuel flow channel at or in the vicinity of the connection part between the first and second in-cell fuel flow channels and the out-cell fuel flow channel.

[19] The fuel cell stack according to any one of claims [15] to [18], wherein the out-cell fuel flow channel includes a main flow channel connected to the inlet, a first branched flow channel connecting an end on the side opposite to the inlet in the main flow channel and the first in-cell fuel flow channel, and a second branched flow channel connecting the end and the second in-cell fuel flow channel, and

the first and second branched flow channels include a flow channel part that extends substantially perpendicularly to a main surface of the first or second fuel cell.

[20] The fuel cell stack according to [19], wherein the first branched flow channel and the first in-cell fuel flow channel form, in their connection part, a flow channel that extends substantially perpendicularly to a main surface of the first fuel cell, and the second branched flow channel and the second in-cell fuel flow channel form, in their connection part, a flow channel that extends substantially perpendicularly to a main surface of the second fuel cell.

[21] The fuel cell stack according to [19], wherein the first branched flow channel and the first in-cell fuel flow channel form, in their connection part, a flow channel that extends substantially parallel with a main surface of the first fuel cell, and the second branched flow channel and the second in-cell fuel flow channel form, in their connection part, a flow channel that extends substantially parallel with a main surface of the second fuel cell.

[22] The fuel cell stack according to any one of [15] to [21], wherein the first fuel cell and the second fuel cell are arranged at a distance so that the side of the first cathode electrode faces the side of the second cathode electrode.

[23] The fuel cell stack according to any one of [15] to [21], wherein the first fuel cell and the second fuel cell are arranged at a distance so that the side of the first cathode electrode faces the side of the second fuel supply portion, or the side of the second cathode electrode faces the side of the first fuel supply portion.

[24] The fuel cell stack according to any one of [15] to [23], including:

a first fuel cell assembly including two or more first fuel cells arranged on the same plane,

a second fuel cell assembly arranged on a main surface of the first fuel cell assembly, the second fuel cell assembly including two or more the second fuel cells arranged on the same plane and arranged to face respective first fuel cells, and

the fuel distribution portion connected to every first and second fuel cell.

[25] The fuel cell stack according to [24], wherein the first fuel cell assembly includes two or more first fuel cells arranged in line, and the second fuel cell assembly includes two or more second fuel cells arranged in line.

[26] The fuel cell stack according to [25], wherein in the first fuel cell assembly, two or more first fuel cells are arranged so that a gap is formed between neighboring two first fuel cells, and in the second fuel cell assembly, two or more second fuel cells are arranged so that a gap is formed between neighboring two second fuel cells.

[27] The fuel cell stack according to [25], wherein the first fuel cell assembly includes two or more first fuel cells arranged in line without any gap, and the second fuel cell assembly includes two or more second fuel cells arranged in line without any gap.

[28] The fuel cell stack according to any one of [15] to [27], which is a direct alcohol type fuel battery.

[29] A fuel cell stack composite including:

a first fuel cell stack which is the fuel cell stack according to any one of [15] to [28]; and

a second fuel cell stack arranged on a main surface of the first fuel cell stack, the second fuel cell stack being the fuel cell stack according to any one of [15] to [28],

wherein an out-cell fuel flow channel of the first fuel cell stack and an out-cell fuel flow channel of the second fuel cell stack communicate with each other, and

at least in a connection part of the out-cell fuel flow channels, a section area of the out-cell fuel flow channel of the second fuel cell stack is larger than a section area of the out-cell fuel flow channel of the first fuel cell stack.

[30] A fuel cell system including:

the fuel cell stack according to any one of [15] to [28] or the fuel cell stack composite according to [29]; and

a fuel tank connected to the fuel cell stack or the fuel cell stack composite, for accommodating the liquid fuel.

[31] The fuel cell system according to [30], further including a liquid sending means for promoting flow of the liquid fuel to the fuel cell stack or fuel cell stack composite from the fuel tank.

According to the present invention, in a fuel cell stack including a plurality of fuel cells stacked thickness-wise, supply of liquid fuel to each fuel cell is uniformized, and hence a fuel cell stack exerting high output, and a fuel cell stack composite and a fuel cell system containing the same can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic perspective view showing one example of a fuel cell stack according to the first embodiment of the present invention.

FIG. 2 is a schematic section view along the line II-II shown in FIG. 1.

FIG. 3 is a schematic section view showing other example of a fuel cell stack according to the first embodiment of the present invention.

FIG. 4 is a schematic section view showing another example of a fuel cell stack according to the first embodiment of the present invention.

FIG. 5 is a schematic section view showing another example of a fuel cell stack according to the first embodiment of the present invention.

FIG. 6 is a schematic section view showing a fuel cell stack of Comparative Example A.

FIG. 7 is a schematic section view showing a fuel cell stack of Comparative Example B.

FIG. 8 is a schematic section view showing a fuel cell stack of Comparative Example C.

FIG. 9 is a schematic section view showing one example of layer configuration of a first fuel cell contained in a fuel cell stack according to the first embodiment.

FIG. 10A is a schematic top view showing one example of a first flow channel plate.

FIG. 10B is a schematic section view of a fuel distribution portion along the line X-X shown in FIG. 10A.

FIG. 11A is a schematic top view showing another example of the first flow channel plate.

FIG. 11B is a schematic section view of a fuel distribution portion along the line XI-XI shown in FIG. 11A.

FIG. 12 is a schematic top view showing another example of the first flow channel plate.

FIG. 13A is a schematic top view showing one example of a first vaporized fuel plate.

FIG. 13B is a schematic section view along the line XIII-XIII shown in FIG. 13A.

FIG. 14A is a schematic top view showing another example of the first vaporized fuel plate.

FIG. 14B is a schematic section view along the line XIV-XIV shown in FIG. 14A.

FIG. 15 is a schematic perspective view showing another example of a fuel cell stack according to the first embodiment of the present invention.

FIG. 16 is a schematic perspective view showing one example of a fuel cell system according to the present invention.

FIG. 17 is a schematic section view showing one example of a fuel cell system according to the present invention.

FIG. 18 is a view showing a temporal change in voltage of each fuel cell after starting of power generation in Example 1.

FIG. 19 is a view showing temporal change in voltage of each fuel cell after starting of power generation in Comparative Example 1.

FIG. 20 is a view showing a measurement result of I-V characteristics for a fuel cell stack of Example 1.

FIG. 21 is a view showing a measurement result of I-V characteristics for a fuel cell stack of Comparative Example 1.

FIG. 22 is a schematic perspective view showing one example of a fuel cell stack according to the second embodiment of the present invention.

FIG. 23 is a schematic section view along the line XXIII-XXIII shown in FIG. 22.

FIG. 24 is a schematic section view showing another example of a fuel cell stack according to the second embodiment of the present invention.

FIG. 25 is a schematic section view showing another example of a fuel cell stack according to the second embodiment of the present invention.

FIGS. 26A and 26B are schematic section views showing exemplary shapes of out-cell fuel flow channel.

FIG. 27 is a schematic section view showing another example of a fuel cell stack according to the second embodiment of the present invention.

FIG. 28 is a schematic section view showing one example of layer configuration of a first fuel cell contained in a fuel cell stack according to the second embodiment.

FIG. 29 is a schematic perspective view showing one example of a fuel cell stack composite according to the present invention.

FIG. 30 is a schematic perspective view showing another example of a fuel cell stack composite according to the present invention.

FIG. 31 is a view showing a measurement result of I-V characteristics for a fuel cell stack of Example 2.

FIG. 32 is a view showing a measurement result of I-V characteristics for a fuel cell stack of Comparative Example 2.

### DESCRIPTION OF THE PREFERRED EMBODIMENTS

In the following, the present invention will be described in detail by way of embodiments of the present invention.

### First Embodiment

### Fuel Cell Stack

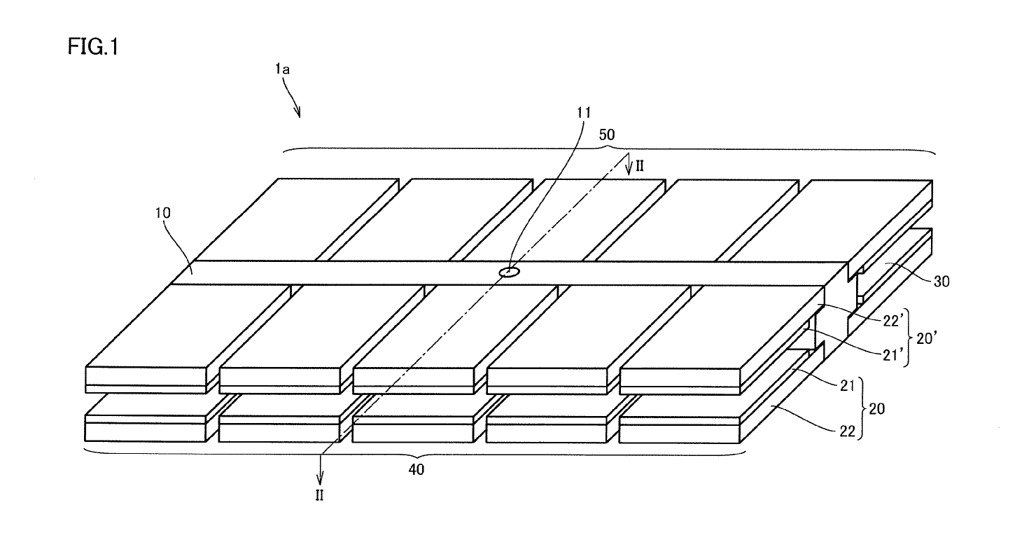

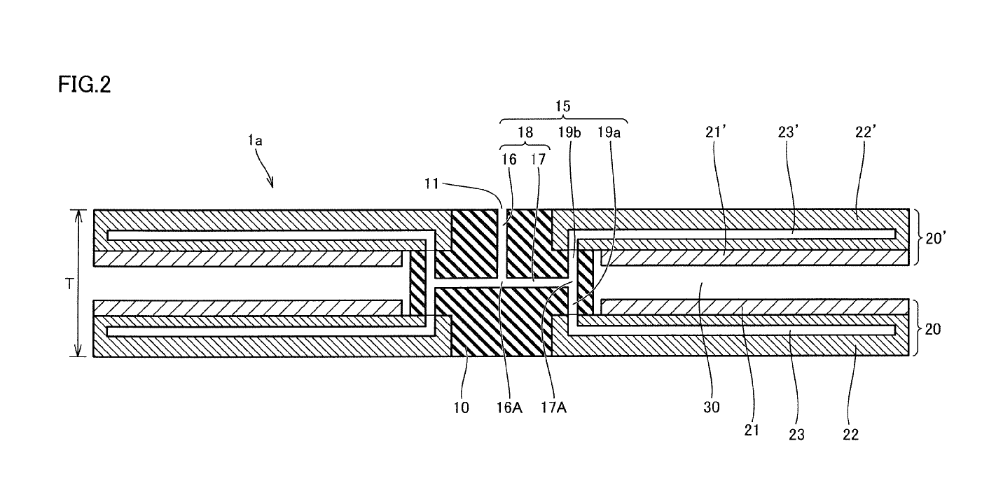

FIG. 1 is a schematic perspective view showing one example of a fuel cell stack according to the present embodiment, and FIG. 2 is a schematic section view along the line II-II shown in FIG. 1. A fuel cell stack 1a shown in these drawings is made up of a total of 20 fuel cells (10 first fuel cells 20 and 10 second fuel cells 20′), and a fuel distribution portion 10 conjoined to all of these fuel cells, for distributing and supplying liquid fuel to each fuel cell.

### [1] General Structure of Fuel Cell Stack

Fuel cell stack 1a includes two or more first fuel cells 20 arranged on the same plane, and two or more second fuel cells 20′ arranged on the same plane. More concretely, fuel cell stack 1a includes a first fuel cell assembly 40 made up of five first fuel cells 20 that are arranged in line at intervals on the same plane; a second fuel cell assembly 50 made up of five second fuel cells 20′ that are arranged in line at intervals on the same plane, arranged above a main surface of first fuel cell assembly 40 (upper side along the thickness direction of first fuel cell assembly 40) at a distance from first fuel cell assembly 40; and fuel distribution portion 10 conjoined to all of first and second fuel cells 20, 20′ (all of first and second fuel cell assemblies 40, 50). Fuel distribution portion 10 is arranged in parallel with the array direction of the fuel cells constituting the fuel cell assembly (longitudinal direction of the fuel cell assembly), on the lateral side of first and second fuel cell assemblies 40, 50 that are arranged to face each other, and is conjoined on its lateral surfaces with first and second fuel cells 20, 20′ respectively constituting first and second fuel cell assemblies 40, 50.

In this example, fuel cell stack 1a has a total of two first fuel cell assemblies 40 and a total of two second fuel cell assemblies 50 conjoined on opposite lateral surfaces of fuel distribution portion 10. The fuel cells constituting fuel cell stack 1a are mutually connected electrically in series or in parallel.

Further, by arranging first fuel cell assembly 40 and second fuel cell assembly 50 at a distance to face each other, a space 30 is formed between first fuel cell assembly 40 and second fuel cell assembly 50. Space 30 forms a supply path for an oxidizing agent (such as air).

Each second fuel cell 20′ constituting second fuel cell assembly 50 is arranged to face each first fuel cell 20 constituting first fuel cell assembly 40 arranged (oppositely arranged) below the same (first fuel cell 20 is arranged directly below that of second fuel cell 20′). A main surface of first fuel cell 20 is substantially parallel with that of second fuel cell 20′. First fuel cell 20 and second fuel cell 20′ are arranged at a distance so that their cathode electrode sides face each other (so that the side of the first cathode electrode faces the side of the second cathode electrode).

First fuel cell 20 includes at least a first power generation portion 21 including a first membrane electrode assembly having a first anode electrode, a first electrolyte membrane and a first cathode electrode in this order, and a first fuel supply portion 22 arranged on the side of the first anode electrode of first power generation portion 21 [See FIG. 1]. First fuel supply portion 22 has a first in-cell fuel flow channel 23 for allowing liquid fuel to communicate (or to diffuse and communicate in a fuel cell surface) [See FIG. 2].

Similarly, second fuel cell 20′ includes at least a second power generation portion 21′ including a second membrane electrode assembly having a second anode electrode, a second electrolyte membrane and a second cathode electrode in this order, and a second fuel supply portion 22′ arranged on the side of the second anode electrode of second power generation portion 21′ [See FIG. 1]. Second fuel supply portion 22′ has a second in-cell fuel flow channel 23′ for allowing liquid fuel to communicate (or to diffuse and communicate in a fuel cell surface) [See FIG. 2].

Fuel distribution portion 10 is an unit for distributing and supplying liquid fuel to each of first and second fuel cells 20, 20′, and has an inlet 11 for introducing liquid fuel on either surface, and an out-cell fuel flow channel 15 for connecting inlet 11 with first and second in-cell fuel flow channels 23, 23′ of first and second fuel cells 20, 20′ inside the same [See FIG. 2]. In fuel cell stack 1a, inlet 11 is provided on an upper surface (a surface forming the same plane with the main surface on the opposite side of first fuel cell assembly 40, in second fuel cell assembly 50) at a longitudinal middle part of fuel distribution portion 10 (a position corresponding to the length-wise center part of fuel cell assembly of the middle fuel cell constituting the fuel cell assembly).

### [2] Fuel Flow Channel Structure

Fuel cell stack 1a has a fuel flow channel for supplying liquid fuel to each fuel cell that forms the same, and as described above, the fuel flow channel includes in-cell fuel flow channels contained in each fuel cell (first and second in-cell fuel flow channels 23, 23′), and out-cell fuel flow channel 15 provided in fuel distribution portion 10, connected to first and second in-cell fuel flow channels 23, 23′.

Referring to FIG. 2, out-cell fuel flow channel 15 includes a first main flow channel 16 extending from inlet 11 downwardly in the direction substantially perpendicular to the main surface of first fuel cell 20 (and second fuel cell 20′) (the direction approaching first fuel cell 20); a second main flow channel 17 connected to an end part 16A on the opposite side of inlet 11 in first main flow channel 16, extending substantially parallel with the main surface of first fuel cell 20 (and second fuel cell 20′) (the direction approaching fuel cell assembly) (hereinafter, first main flow channel 16 and second main flow channel 17 are collectively called “main flow channel 18”); a first branched flow channel 19a connecting an end part 17A on the side opposite to inlet 11 in main flow channel 18 (the end on the opposite side to end part 16A in second main flow channel 17) and first in-cell fuel flow channel 23; and a second branched flow channel 19b connecting end part 17A and second in-cell fuel flow channel 23′.

In the cross section shown in FIG. 2, a total of two second main flow channels 17 extend from end part 16A to both lateral surfaces of fuel distribution portion 10, so as to allow fuel supply to a group of fuel cell assemblies arranged on both lateral surfaces. First and second branched flow channels 19a, 19b extend substantially perpendicularly to main surfaces of first fuel cell 20 (and second fuel cell 20′).

Although not illustrated in the drawings, out-cell fuel flow channel 15 has a third main flow channel for supplying liquid fuel to fuel cells other than the middle fuel cells constituting first and second fuel cell assemblies 40, 50, that extends from end part 16A in the longitudinal direction of fuel distribution portion 10 (array direction of fuel cells constituting first and second fuel cell assemblies 40, 50) as a part of main flow channel 18. This third main flow channel is provided with second main flow channel 17 and first and second branched flow channels 19a, 19b having similar structures as shown in FIG. 2 connected to in-cell fuel channels contained in fuel cells other than the middle fuel cells. That is, fuel cell stack 1a has one first main flow channel 16, a total of 10 second main flow channels 17, one third main flow channel, a total of 10 first branched flow channels 19a and a total of 10 second branched flow channels 19b.

In the present description, “main flow channel” which is a part of the fuel flow channel refers to a flow channel through which liquid fuel that is to be distributed and supplied to oppositely-arranged first fuel cell 20 and second fuel cell 20′ commonly flows, and more concretely, means the flow channel other than in-cell flow channels and first and second branched flow channels.

In the flow channel structure as described above, in fuel cell stack 1a, between every first fuel cell 20 and every second fuel cell 20′ (hence, between oppositely-arranged first fuel cell 20 and second fuel cell 20′), a total length of first branched flow channel 19a and first in-cell fuel flow channel 23 (flow channel length from end part 17A to the terminal of first in-cell fuel flow channel 23), and a total length of second branched flow channel 19b and second in-cell fuel flow channel 23′ (flow channel length from end part 17A to the terminal of second in-cell fuel flow channel 23′) are substantially identical.

The relationship in total length as described above is realized by disposing second main flow channel 17 at a middle position along the thickness direction of fuel distribution portion 10, namely at a position of equal distance from both the main surface of first fuel supply portion 22 and the main surface of second fuel supply portion 22′ that face each other, in substantially parallel with the main surface of first fuel cell 20 (and second fuel cell 20′) (therefore, the flow channel length of first branched flow channel 19a and the flow channel length of second branched flow channel 19b are identical), and using first and second fuel cells 20, 20′ in which first and second in-cell fuel flow channels 23, 23′ are arranged at identical thickness-wise positions to first and second fuel supply portions 22, 22′ (therefore, referring to FIG. 2, the flow channel length of substantially L-shaped first in-cell fuel flow channel 23 formed by a flow channel part extending substantially perpendicularly to the main surface of fuel cell and a flow channel part extending substantially parallel with the main surface of fuel cell is identical to the flow channel length of substantially L-shaped second in-cell fuel flow channel 23′).

According to fuel cell stack 1a having the relationship in total length as described above, although the fuel flow channel includes first and second branched flow channels 19a, 19b that extends substantially perpendicularly to the main surface of first fuel cell 20 (and second fuel cell 20′), the liquid fuel having reached end part 17A through main flow channel 18 by capillary force is uniformly branched into first branched flow channel 19a and second branched flow channel 19b, and uniformly supplied to first fuel cell 20 and second fuel cell 20′ by capillary force.

The section area of each of first in-cell fuel flow channel 23, second in-cell fuel flow channel 23′ and out-cell fuel flow channel 15 is preferably within the range of 100 μm² to 1 mm², and more preferably within the range of 2500 μm² to 10000 μm² so that movement of liquid fuel occurs mainly by capillary force.

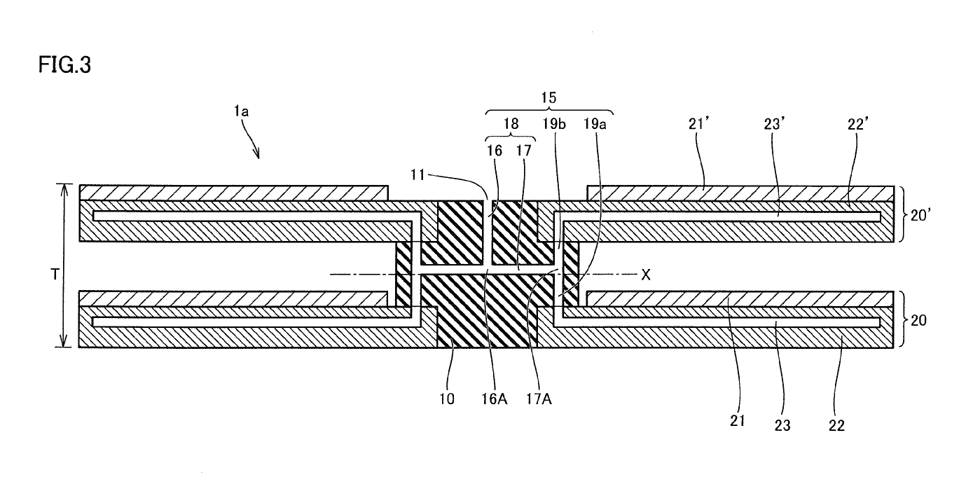

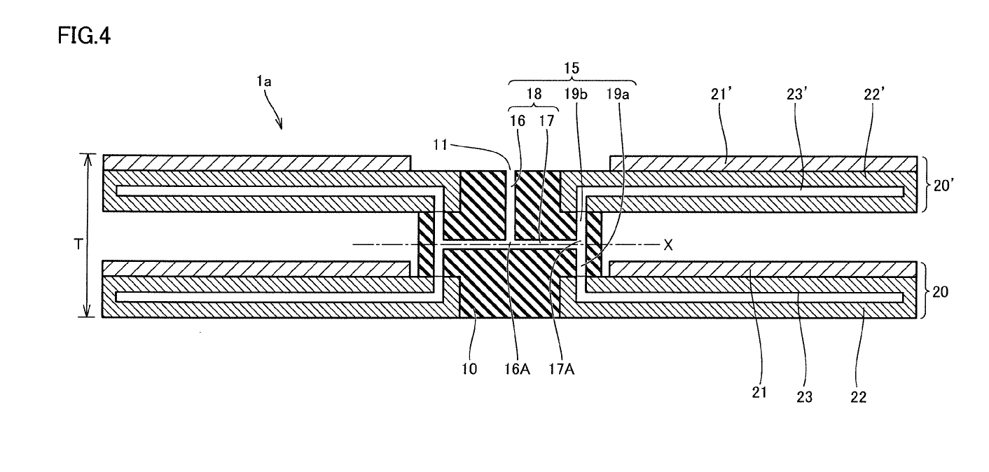

FIG. 3 and FIG. 4 are schematic section views similar to FIG. 2, showing other examples of a fuel cell stack according to the present embodiment. As shown in these drawings, first fuel cell 20 and second fuel cell 20′ arranged on its main surface (oppositely arranged) may be arranged at a distance so that the cathode electrode side of either one of the fuel cells faces the fuel supply portion side of the other of the fuel cells, namely, the first cathode electrode side faces the second fuel supply portion side, or the second cathode electrode side faces the first fuel supply portion side, rather than they are arranged so that their cathode electrode sides face each other.

In the example of FIG. 3, first and second in-cell fuel flow channels 23, 23′ are arranged in such a manner that the flow channel parts extending substantially parallel with the main surface of fuel cell are at an equal distance respectively from first and second power generation portions 21, 21′, however, in first fuel cell 20, there is a connection part between first branched flow channel 19a and first in-cell fuel flow channel 23 on the main surface on the side of first power generation portion 21 of first fuel supply portion 22, and in second fuel cell 20′, there is a connection part between second branched flow channel 19b and second in-cell fuel flow channel 23′ on the main surface on the side opposite to second power generation portion 21′ of second fuel supply portion 22′, so that the flow channel length of the flow channel part extending substantially perpendicular to the main surface of fuel cell in first in-cell fuel flow channel 23 is shorter than the flow channel length of the flow channel part extending substantially perpendicularly to the main surface of fuel cell in second in-cell fuel flow channel 23′.

Therefore, in the example of FIG. 3, in order to making first branched flow channel 19a longer than second branched flow channel 19b, thereby making a total length of first branched flow channel 19a and first in-cell fuel flow channel 23 substantially identical to a total length of second branched flow channel 19b and second in-cell fuel flow channel 23′, second main flow channel 17 is arranged not at the middle position (position of X in FIG. 3) along the thickness direction of fuel distribution portion 10 but at the position closer to second fuel cell 20′ than the middle position.

In the example of FIG. 4, in first and second in-cell fuel flow channels 23, 23′, the flow channel parts extending substantially parallel with the main surface of fuel cell are arranged respectively, at a middle position along the thickness direction in first and second fuel supply portions 22, 22′, and first in-cell fuel flow channel 23 and second in-cell fuel flow channel 23′ have an identical flow channel length. Therefore, in the example of FIG. 4, by disposing second main flow channel 17 at a middle position along the thickness direction of fuel distribution portion 10 (the position of X in FIG. 4), the aforementioned relationship in total length is realized.

Of the examples described above, the example shown in FIG. 2 has the following advantages.

(i) Since first fuel cell 20 is arranged to face second fuel cell 20′ so that the first cathode electrode side faces the second cathode electrode side, thickness of the thickest part of fuel cell stack 1a [T in FIG. 2] can be made smaller than those in the examples of FIG. 3 and FIG. 4.

(ii) Unlike the examples of FIG. 3 and FIG. 4, an oxidizing agent supply path for first fuel cell 20 and an oxidizing agent supply path for second fuel cell 20′ can be made common (that is, space 30 is a common oxidizing agent supply path).

(iii) Unlike the examples of FIG. 3 and FIG. 4, first fuel cell 20 and second fuel cell 20′ can be embodied by a fuel cell of the same structure (In the examples of FIG. 3 and FIG. 4, fuel cells having different structures of in-cell fuel flow channels are used.).

(iv) Unlike the example of FIG. 4, in realizing the relationship in total length, it is not necessarily to dispose the flow channel parts extending substantially parallel with the main surface of fuel cell in first and second in-cell fuel flow channels 23, 23′ at a center position along the thickness direction in first and second fuel supply portions 22 22′.

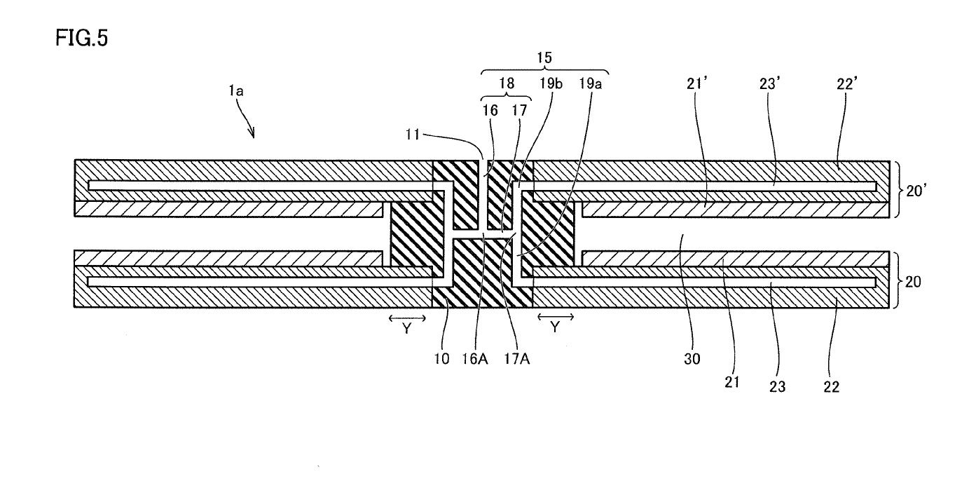

In the examples of FIG. 2 to FIG. 4, first branched flow channel 19a and first in-cell fuel flow channel 23, and second branched flow channel 19b and second in-cell fuel flow channel 23′ are connected respectively in such a manner that they form flow channels extending substantially perpendicular to the main surfaces of first fuel cell 20 and second fuel cell 20′ in their connection parts, however, this connecting manner is not limitative. For example, as shown in FIG. 5, first branched flow channel 19a and first in-cell fuel flow channel 23, and second branched flow channel 19b and second in-cell fuel flow channel 23′ may be connected respectively in such a manner that they form flow channels extending substantially parallel with the main surfaces of first fuel cell 20 and second fuel cell 20′ in their connection parts. In this case, first and second branched flow channels 19a, 19b may be, for example, substantially L-shaped flow channels each consisting of a flow channel part extending substantially perpendicularly to the main surface of fuel cell and a flow channel part extending substantially parallel with the surface of fuel cell, and first and second in-cell fuel flow channels 23, 23′ may be embodied by flow channels extending substantially parallel with the main surface of fuel cell.

The fuel flow channel structure as shown in the example of FIG. 5 is able to omit a part of fuel distribution portion 10 [the region represented by Y in FIG. 5] or to reduce the width of the region, and is advantageous in that the width of the fuel cell, and hence the width of the fuel cell stack can be reduced.

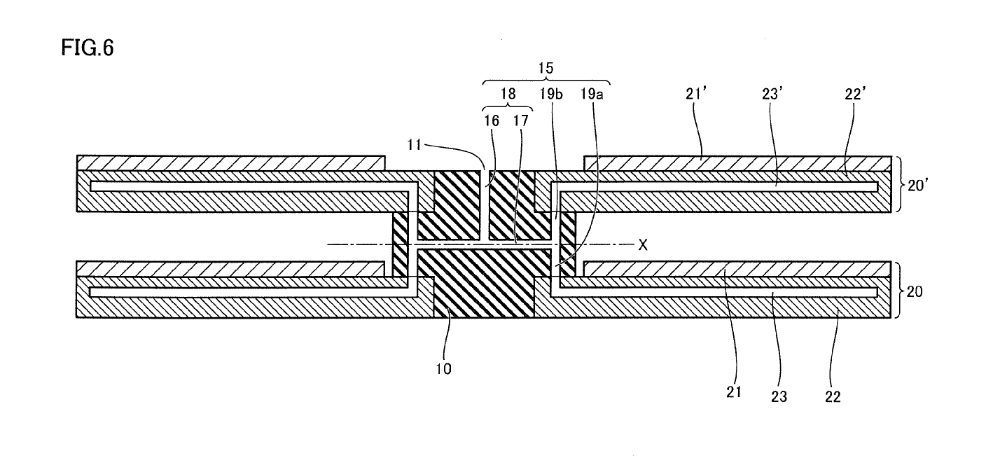

Examples of fuel cell stacks that fail to satisfy the relationship in total length, which are Comparative Examples of the present invention will be shown in FIG. 6 to FIG. 8 (respectively called Comparative Examples A to C). All of these FIG. 6 to FIG. 8 are schematic section views similar to FIG. 2 in a fuel cell stack.

The fuel cell stack in Comparative Example A shown in FIG. 6 is identical to the example of FIG. 3 except that second main flow channel 17 is arranged at a middle position along the thickness direction of fuel distribution portion 10 [the position of X in FIG. 6]. As a result, the total length of first branched flow channel 19a and first in-cell fuel flow channel 23 is shorter than the total length of second branched flow channel 19b and second in-cell fuel flow channel 23′.

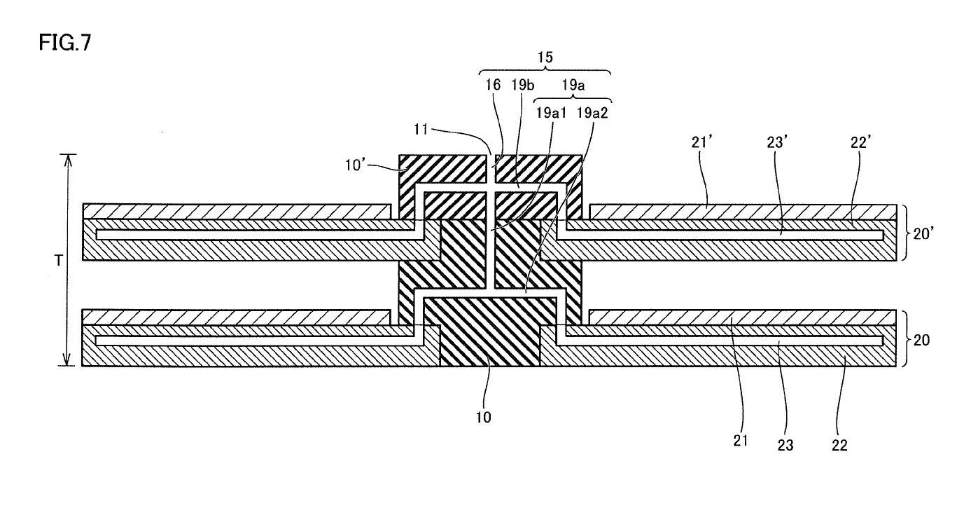

The fuel cell stack in Comparative Example B shown in FIG. 7 is an example in which a second fuel distribution portion 10′ containing a part of out-cell fuel flow channel 15 is further arranged on fuel distribution portion 10. In this Comparative Example, out-cell fuel flow channel 15 includes a main flow channel embodied by first main flow channel 16, first branched flow channel 19a made up of a flow path 19a1 and a substantially L-shaped flow channel 19a2, and substantially L-shaped second branched flow channel 19b. Since the flow channel length of first branched flow channel 19a differs from the flow channel length of second branched flow channel 19b, the aforementioned relationship in total length is not satisfied. Further, as a result of arrangement of second fuel distribution portion 10′, the thickness of the thickest part [T in FIG. 7] is significantly large.

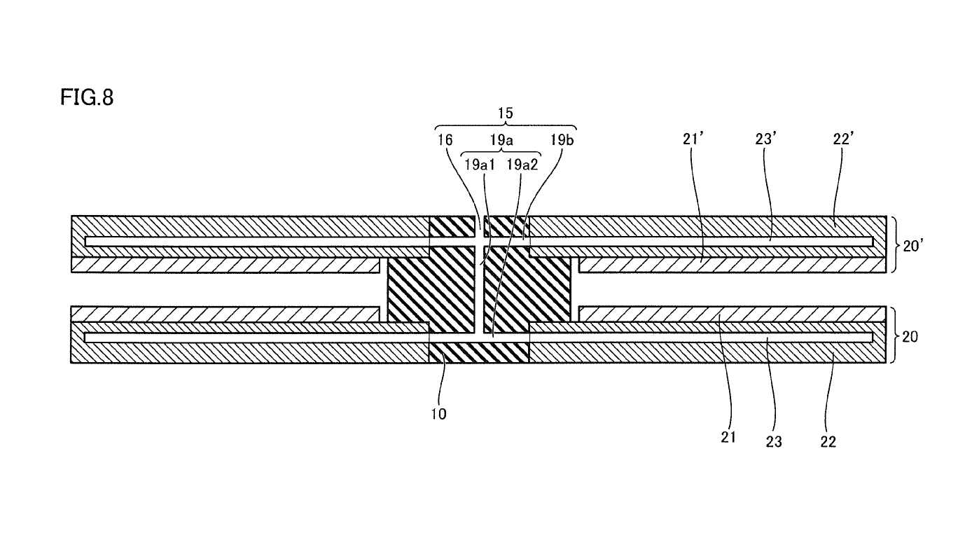

The fuel cell stack in Comparative Example C shown in FIG. 8 is similar to the example of FIG. 5 except that out-cell fuel flow channel 15 is composed of a main flow channel made up of first main flow channel 16, first branched flow channel 19a made up of flow channel 19a1 and flow channel 19a2, and second branched flow channel 19b. Since the flow channel length of first branched flow channel 19a differs from the flow channel length of second branched flow channel 19b, the aforementioned relationship in total length is not satisfied.

### [3] First Fuel Cell

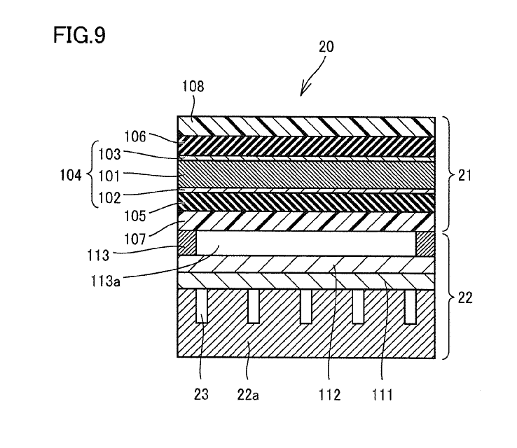

FIG. 9 is a schematic section view showing one example of layer configuration of first fuel cell 20, and shows the cross section in the direction perpendicular to the cross section shown in FIG. 2. In the example shown in FIG. 9, first fuel cell 20 includes: a first membrane electrode assembly 104 having a first anode electrode 102, a first electrolyte membrane 101 and a first cathode electrode 103 in this order; a first anode collecting layer 105 stacked on first anode electrode 102 and electrically connected thereto; a first cathode collecting layer 106 stacked on first cathode electrode 103 and electrically connected thereto; a first anode moisturizing layer 107 stacked on first anode collecting layer 105 in contact with first anode collecting layer 105; a first cathode moisturizing layer 108 stacked on first cathode collecting layer 106 in contact with first cathode collecting layer 106; a first flow channel plate 22a arranged on the side of first anode electrode 102, having first in-cell fuel flow channel 23 for allowing liquid fuel to communicate (diffuse and communicate in a fuel cell surface); a first gas-liquid separating layer 112 arranged between first membrane electrode assembly 104 and first flow channel plate 22a, allowing permeation of a vaporized component of liquid fuel; a first vaporized fuel plate 113 arranged between first gas-liquid separating layer 112 and first anode moisturizing layer 107, having a vaporized fuel accommodating portion 113a; and a first intermediate layer 111 arranged between first gas-liquid separating layer 112 and first flow channel plate 22a in such a manner that it covers first in-cell fuel flow channel 23.

In the example shown in FIG. 9, first power generation portion 21 is made up of first cathode moisturizing layer 108, first cathode collecting layer 106, first membrane electrode assembly 104, first anode collecting layer 105 and first anode moisturizing layer 107, and first fuel supply portion 22 is made up of first vaporized fuel plate 113, first gas-liquid separating layer 112, first intermediate layer 111 and first flow channel plate 22a.

(First Electrolyte Membrane)

First electrolyte membrane 101 constituting first membrane electrode assembly 104 has a function of transmitting a proton from first anode electrode 102 to first cathode electrode 103, and a function of keeping electric insulation between first anode electrode 102 and first cathode electrode 103 to prevent short-circuiting. The material of first electrolyte membrane 101 is not particularly limited insofar as it has proton conductivity and electric insulation property, and may be a polymer film, an inorganic film or a composite film. Examples of polymer films include perfluorosulfonic acid based electrolyte membranes such as Nafion (registered trade name, available from DuPont), Aciplex (registered trade name, available from Asahi Kasei Corporation) and Flemion (registered trade name, available from ASAHI GLASS Co., Ltd.). Also hydrocarbon based electrolyte membranes such as styrene based graft polymer, trifluorostyrene derivative copolymer, sulfonated polyarylene ether, sulfonated polyether ether ketone, sulfonated polyimide, sulfonated polybenzoimidazole, phosphonated polybenzoimidazole and sulfonated polyphosphazene may be used.

Examples of inorganic films include films formed of phosphate glass, cesium hydrogen sulfide, polytungstophosphoric acid and ammonium polyphosphate. Examples of composite films include composite films of inorganic substances such as tungstic acid, cesium hydrogen sulfide and polytungstophosphoric acid, and organic substances such as polyimide, polyetheretherketone and perfluorosulfonic acid. The film thickness of first electrolyte membrane 101 is for example, 1 to 200 μm.

(First Anode Electrode and First Cathode Electrode)

First anode electrode 102 stacked on one surface of first electrolyte membrane 101 and first cathode electrode 103 stacked on the other surface each are provided with a catalyst layer formed of a porous layer containing at least a catalyst and an electrolyte. In first anode electrode 102, the catalyst (anode catalyst) catalyzes the reaction of generating a proton and an electron from fuel, and the electrolyte has a function of conducting the generated proton to first electrolyte membrane 101. In first cathode electrode 103, the catalyst catalyzes the reaction of generating water from the proton having transmitted the electrolyte and an oxidizing agent (such as air).

The catalysts of first anode electrode 102 and first cathode electrode 103 may be carried on the surface of a conductor such as carbon or titanium, and among others, they are preferably carried on the surface of a conductor such as carbon or titanium having a hydrophilic functional group such as hydroxyl group or carboxyl group. As a result, it is possible to improve the water retentivity of first anode electrode 102 and first cathode electrode 103. By the improvement of the water retentivity, it is possible to ameliorate the resistance of first electrolyte membrane 101 in association with proton movement, and potential distribution in first anode electrode 102 and first cathode electrode 103.

First anode electrode 102 and first cathode electrode 103 may be provided with an anode conductive porous layer (anode gas diffusion layer) and a cathode conductive porous layer (cathode gas diffusion layer) stacked on the catalyst layer respectively. These conductive porous layers has a function of diffusing the gas (vaporized fuel or oxidizing agent) supplied to first anode electrode 102 and first cathode electrode 103 within the surface, and a function of giving/receiving an electron to/from the catalyst layer. As the anode conductive porous layer and the cathode conductive porous layer, it is preferred to use porous materials formed of carbon materials; conductive polymers; noble metals such as Au, Pt and Pd; transition metals such as Ti, Ta, W, Nb, Ni, Al, Cu, Ag and Zn; nitrides and carbides of these metals; and alloys containing these metals represented by stainless because they have low specific resistance and repress decrease in voltage. When metal having poor corrosion resistance under an acidic atmosphere, such as Cu, Ag or Zn is used, it may be subjected to a surface treatment (film formation) with noble metal having corrosion resistance such as Au, Pt or Pd, conductive polymer, conductive nitride, conductive carbide or conductive oxide. More concretely, as the anode conductive porous layer and the cathode conductive porous layer, for example, foam metal, woven metal and sintered metal formed of the aforementioned noble metal, transition metal or alloy; and carbon paper, carbon cloth, an epoxy resin film containing carbon particles and the like can be preferably used.

(First Anode Collecting Layer and First Cathode Collecting Layer)

First anode collecting layer 105 and first cathode collecting layer 106 are stacked respectively on first anode electrode 102 and on first cathode electrode 103. First anode collecting layer 105 and first cathode collecting layer 106 have a function of collecting electrons respectively in first anode electrode 102 and in first cathode electrode 103, and a function of achieving electric wiring. Materials for the collecting layers are preferably metal because the specific resistance is small and decrease in voltage is repressed even when the current is taken out in the planar direction, and among others, metal having electron conductivity and corrosion resistance under an acidic atmosphere is more preferred. Examples of such metal include noble metals such as Au, Pt and Pd; transition metals such as Ti, Ta, W, Nb, Ni, Mo, Co, Al, Cu, Ag and Zn; nitrides and carbides of these metals; and alloys containing these metals represented by stainless. When metal having poor corrosion resistance under an acidic atmosphere such as Cu, Ag or Zn is used, it may be subjected to a surface treatment (film formation) with noble metal having corrosion resistance such as Au, Pt or Pd, conductive polymer, conductive nitride, conductive carbide, conductive oxide or the like. When the anode conductive porous layer and the cathode conductive porous layer are formed, for example, of metal or the like, and thus have relatively high conductivity, the first anode collecting layer and the first cathode collecting layer may be omitted.

More concretely, first anode collecting layer 105 may be a mesh-form or a punching metal-form flat plate formed of the aforementioned metal materials and so on, having a plurality of through-holes (openings) penetrating thickness-wise for guiding the vaporized fuel to first anode electrode 102. These through-holes also function as a path for guiding byproduct gas (such as CO₂ gas) generated in the catalyst layer of first anode electrode 102 toward the side of vaporized fuel accommodating portion 113a. Likewise, first cathode collecting layer 106 may be a mesh-form or a punching metal-form flat plate formed of the aforementioned metal materials and so on, having a plurality of through-holes (openings) penetrating thickness-wise for supplying an oxidizing agent (for example, air outside the fuel cell) to the catalyst layer of first cathode electrode 103.

(First Flow Channel Plate)

First flow channel plate 22a may be a plate-like body with first in-cell fuel flow channel 23 for allowing liquid fuel to communicate formed on the surface on the side of first anode electrode 102. First in-cell fuel flow channel 23 may be embodied, for example, by a groove (recess) formed on one surface of the aforementioned plate-like body. The shape (pattern) of first in-cell fuel flow channel 23 is not particularly limited, and preferably it is arranged uniformly over as wide as possible range so that the vaporized fuel can be supplied as uniformly as possible over the whole surface of first anode electrode 102.

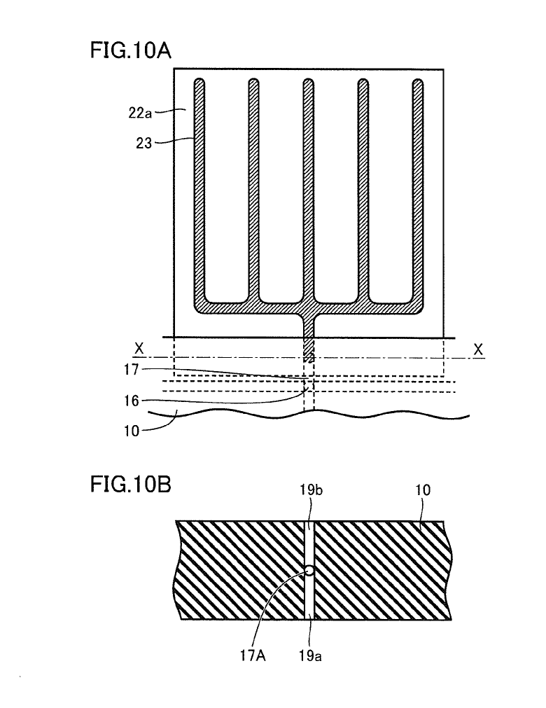

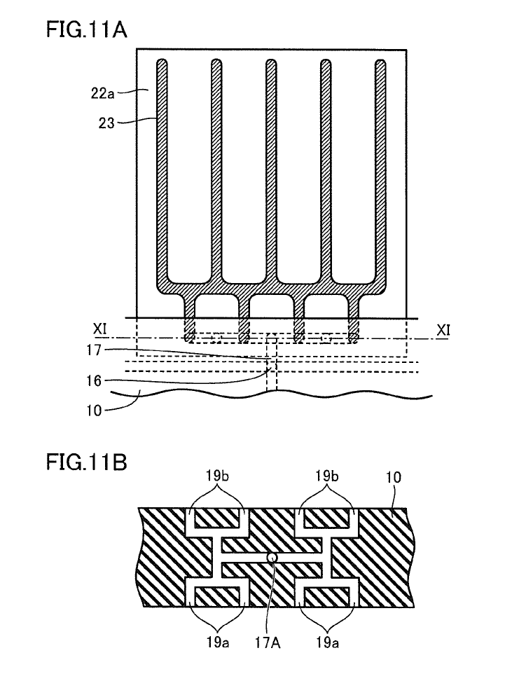

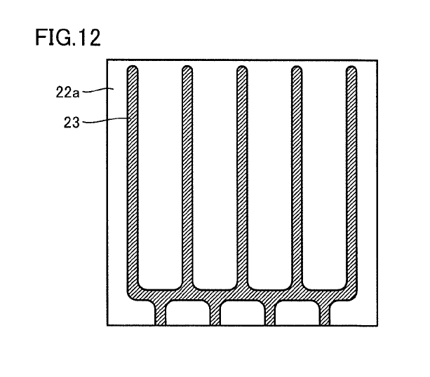

In FIG. 10A, FIG. 11A and FIG. 12, examples of flow channel patterns of first in-cell fuel flow channel 23 are shown. Every first in-cell fuel flow channel 23 (hatched part) depicted in these drawings is embodied by a groove (recess). FIG. 1 OA and FIG. 11A show the surface formed with first in-cell fuel flow channel 23 in first flow channel plate 22a in a schematic top view, and shows the condition that a part of fuel distribution portion 10 is stacked on first flow channel plate 22a so that first in-cell fuel flow channel 23 and out-cell fuel flow channel 15 of fuel distribution portion 10 are connected as shown in FIG. 2, in a schematic top view. FIG. 10B and FIG. 11B are respectively schematic section views of fuel distribution portion 10 along the line X-X and the line XI-XI shown in FIG. 1 OA and FIG. 11A.

In examples of FIGS. 10A and 10B, while there is only one connection point between first in-cell fuel flow channel 23 of first flow channel plate 22a and out-cell fuel flow channel 15 of fuel distribution portion 10 (more concretely first branched flow channel 19a) (in other words, there is only one inlet of first in-cell fuel flow channel 23), first in-cell fuel flow channel 23 has a pectinatedly branched structure so that it has a total of five branched flow channels extending substantially parallel with each other at equal intervals. With such a branched structure, it is possible to supply vaporized fuel more uniformly over the whole surface of first anode electrode 102.

As described above, when first and second in-cell fuel flow channels 23, 23′ have only one inlet, and first and second in-cell fuel flow channels 23, 23′ are made up of a plurality of branched flow channels (when each one of first and second in-cell fuel flow channels 23, 23′ is branched into a plurality of flow channels on the route to the terminal), the phrasing that the total length of first branched flow channel 19a and first in-cell fuel flow channel 23 (the flow channel length from end part 17A to the terminal of first in-cell fuel flow channel 23), and the total length of second branched flow channel 19b and second in-cell fuel flow channel 23′ (the flow channel length from end part 17A to the terminal of second in-cell fuel flow channel 23′) are substantially identical means that the total lengths are identical with regard to branched flow channels arranged to face each other (branched flow channels at the identical positions in the flow channel planar direction) contained in first and second in-cell fuel flow channels 23, 23′. In other words, it means that when a path including a certain one branched flow channel is selected as first in-cell fuel flow channel 23 among the plural paths running from end part 17A to the terminal of first in-cell fuel flow channel 23 made up of first branched flow channel 19a and first in-cell fuel flow channel 23, and a path including the branched flow channel arranged to face the branched flow channel selected in the above is selected among the plural paths running from end part 17A to the terminal of second in-cell fuel flow channel 23′, and these selected flow channel lengths are compared, the aforementioned relationship in total length is satisfied, and the relationship is satisfied for all of the branched flow channels arranged to face each other. Typically, as a flow channel plate (second flow channel plate) of second fuel cell 20′ arranged to face first fuel cell 20 including first flow channel plate 22a, the one having second in-cell fuel flow channel 23′ having the same form as that of first in-cell fuel flow channel 23 contained in first flow channel plate 22a is used.

On the other hand, as shown in FIGS. 11A and 11B, it is also possible to make first branched flow channel 19a of out-cell fuel flow channel 15 be branched [see FIG. 11B], and in association with this, a plurality of inlets of first in-cell fuel flow channel 23 may be provided and first in-cell fuel flow channel 23 may be made up of a plurality of branched flow channels similarly to the example of FIG. 10 A (in the example of FIGS. 11A and 11B, there are four inlets, and first in-cell fuel flow channel 23 has five branched flow channels). When both first and second in-cell fuel flow channels 23, 23′ have such a structure, the phrasing that the total length of first branched flow channel 19a and first in-cell fuel flow channel 23 (the flow channel length from end part 17A to the terminal of first in-cell fuel flow channel 23) is substantially identical to the total length of second branched flow channel 19b and second in-cell fuel flow channel 23′ (the flow channel length from end part 17A to the terminal of second in-cell fuel flow channel 23′) means that when any of path is selected among the plural paths running from end part 17A to the terminal of first in-cell fuel flow channel 23, and when any of path is selected among the plural paths running from end part 17A to the terminal of second in-cell fuel flow channel 23′, the aforementioned relationship in total length is satisfied when these selected flow channel lengths are compared. Typically, as a flow channel plate (second flow channel plate) of second fuel cell 20′ arranged to face first fuel cell 20 including first flow channel plate 22a, the one having second in-cell fuel flow channel 23′ having the same form as that of first in-cell fuel flow channel 23 contained in first flow channel plate 22a is used.

FIG. 12 is a schematic top view showing another example of first flow channel plate, and shows another example of a flow channel pattern of first in-cell fuel flow channel 23. The flow channel form in FIG. 12 is similar to that in FIG. 11A, but is different from FIG. 11A in that first in-cell fuel flow channel 23 extends to one end surface (lateral surface) of first flow channel plate 22a, and the end surface is provided with four inlets. The flow channel plate having such a structure may be used in an embodiment in which an in-cell fuel flow channel and an out-cell fuel flow channel are connected at the lateral surface of the flow channel plate as is the case with the fuel cell stack shown in FIG. 5.

First flow channel plate 22a may be fabricated from a plastic material, a metal material or the like. Examples of plastic materials include polyphenylene sulfide (PPS), poly(methyl methacrylate) (PMMA), acrylonitrile butadiene styrene (ABS), polyvinyl chloride, polyethylene (PE), polyethylene terephthalate (PET), polyether ether ketone (PEEK), polytetrafluoroethylene (PTFE) and polyvinylidene fluoride (PVDF). Examples of metal materials that can be used include titanium and aluminum, as well as alloy materials such as stainless and magnesium alloys.

(First Vaporized Fuel Plate)

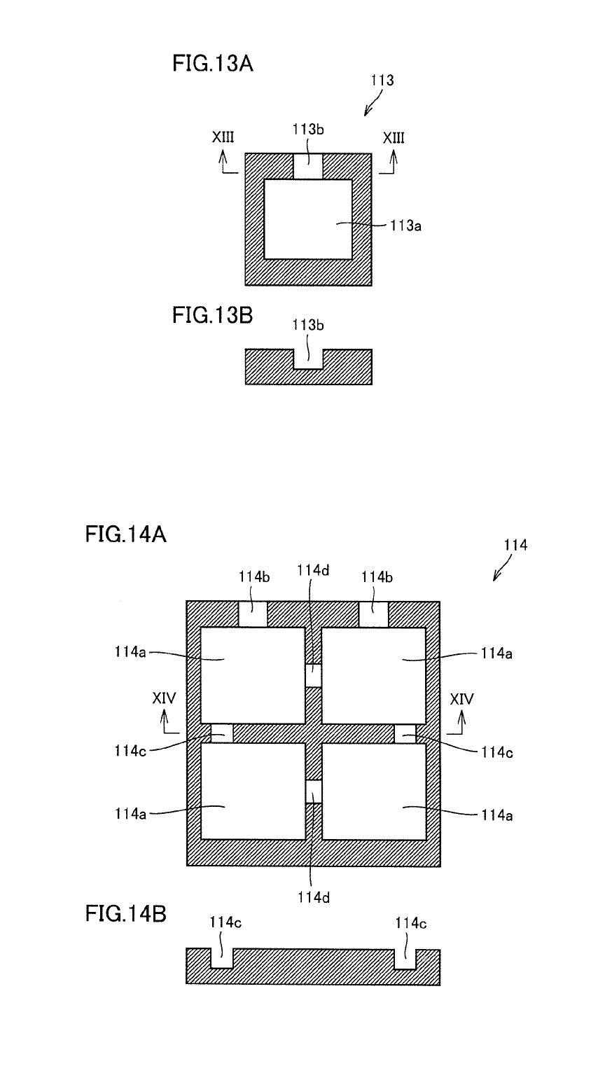

FIG. 13A is a schematic top view showing first vaporized fuel plate 113 used in first fuel cell 20 shown in FIG. 9, and FIG. 13B is a schematic section view along the line XIII-XIII shown in FIG. 13A. First vaporized fuel plate 113 is a member for forming a space for accommodating vaporized fuel between first membrane electrode assembly 104 and first gas-liquid separating layer 112 (namely, vaporized fuel accommodating portion 113a). In the example of FIG. 9, first vaporized fuel plate 113 is arranged between first anode moisturizing layer 107 and first gas-liquid separating layer 112 in contact with first anode moisturizing layer 107. First vaporized fuel plate 113 has vaporized fuel accommodating portion 113a which is a pass-through ports penetrating thickness-wise, and a communication path 113b that allows communication between vaporized fuel accommodating portion 113a and outside of first vaporized fuel plate 113. Communication path 113b is a path for discharging byproduct gas (such as CO₂ gas) generated in first anode electrode 102 outside the fuel cell.

Communication path 113b is formed in a peripheral part of first vaporized fuel plate 113, and is embodied by a groove (recess) extending from vaporized fuel accommodating portion 113a to an end surface of the peripheral part. An outlet of communication path 113b is formed, for example, on a lateral surface opposed to the fuel cell lateral surface to which fuel distribution portion 10 is conjoined.

By providing vaporized fuel accommodating portion 113a on first in-cell fuel flow channel 23 with first gas-liquid separating layer 112 interposed therebetween, uniformization of vaporized fuel concentration supplied to first anode electrode 102 in the surface of first anode electrode 102, and optimization of vaporized fuel amount are promoted.

Provision of vaporized fuel accommodating portion 113a is advantageous also in the following points.

(i) By the air layer existing in vaporized fuel accommodating portion 113a, heat insulation between first membrane electrode assembly 104 and first in-cell fuel flow channel 23 can be achieved. As a result, it is possible to repress the crossover due to excessive increase in temperature of liquid fuel in first in-cell fuel flow channel 23. This contributes to repressing runaway of the internal temperature and increase in the internal pressure of the fuel cell.

(ii) Byproduct gas such as CO₂ generated in first anode electrode 102 reaches inside vaporized fuel accommodating portion 113a while it is accompanied by heat generated by power generation, and is then discharged outside fuel cell through communication path 113b. As a result, it is possible to greatly reduce the quantity of heat accumulated in the fuel cell, and hence to repress excessive temperature rise as the whole fuel cell including first in-cell fuel flow channel 23. This also contributes to repressing runaway of the internal temperature and increase in the internal pressure in the fuel cell. In particular, by providing first vaporized fuel plate 113 with communication path 113b (discharge port for byproduct gas), heat conduction to first in-cell fuel flow channel 23 is difficult to occur, and hence excessive temperature rise in liquid fuel existing in first in-cell fuel flow channel 23 and cross over and temperature runaway in association with this are difficult to occur.

(iii) Since byproduct gas can be desirably discharged through communication path 113b, it is possible to repress fuel supply inhibition by defective discharge of byproduct gas, and to desirably supply fuel to first anode electrode 102. As a result, it is possible to obtain stable power generating characteristics. Further, since it is possible to desirably discharge byproduct gas through communication path 113b, it is possible to prevent byproduct gas from entering inside first in-cell fuel flow channel 23. As a result, it becomes possible to supply a sufficient amount of vaporized fuel stably to first anode electrode 102, and hence output stability of the fuel cell can be improved.

The thickness of first vaporized fuel plate 113 may be for example, about 100 to 1000 μm, and even when it is reduced to about 100 to 300 μm, the effects as described above can be sufficiently obtained.

As to the pass-through port (vaporized fuel accommodating portion 113a) contained in first vaporized fuel plate 113, it is preferred that the aperture ratio relative to the area of first vaporized fuel plate 113 is as high as possible as shown in FIG. 13A from the view point of heat insulation between first membrane electrode assembly 104 and first in-cell fuel flow channel 23, and hence, it is preferred that first vaporized fuel plate 113 has a frame form having a pass-through port of as large as possible.

The aperture ratio of a pass-through port, namely, the ratio of an opening area of pass-through port (as will be described later, first vaporized fuel plate 113 may have two or more pass-through ports, and in such a case, a total of opening areas of these) relative to the area of first vaporized fuel plate 113 is preferably greater than or equal to 50%, and more preferably greater than or equal to 60%. Larger aperture ratio of pass-through port is advantageous in enhancing the ability of vaporized fuel accommodating portion 113a to uniformize the fuel concentration supplied to first anode electrode 102, and also advantageous in ensuring sufficient fuel supply to first anode electrode 102. The aperture ratio of pass-through port is typically less than or equal to 90%.

Communication path 113b is not limited to a groove (recess) provided in the peripheral part of first vaporized fuel plate 113, but may be a pass-through port penetrating along the thickness direction, however, from the view point of strength, it is embodied by a groove (recess). From the view point of strength of first vaporized fuel plate 113, the depth of communication path 113b is preferably up to about 75% of the thickness of first vaporized fuel plate 113.

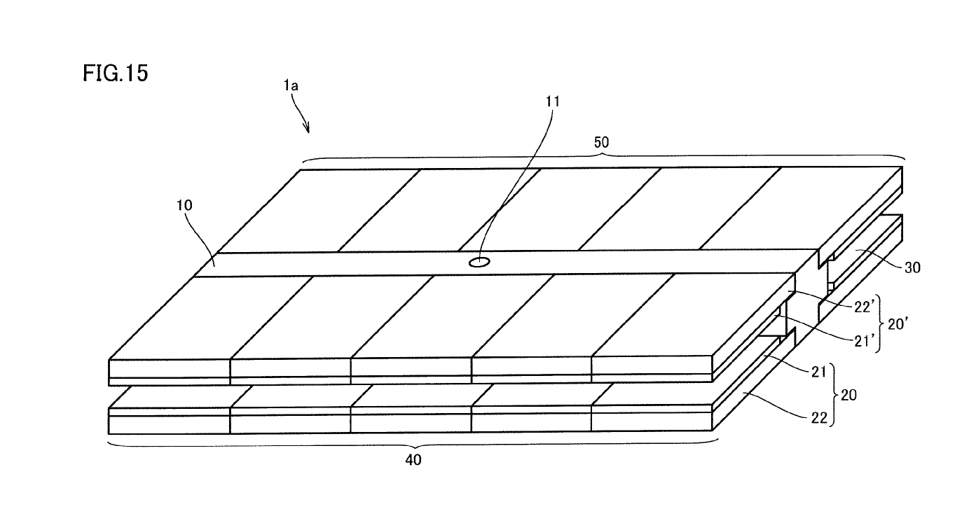

FIG. 14A is a schematic top view showing another example of the first vaporized fuel plate, and FIG. 14B is a schematic section view along the line XIV-XIV shown in FIG. 14A. As shown in FIG. 14A, the first vaporized fuel plate may have two or more pass-through ports. First vaporized fuel plate 114 shown in FIGS. 14A and 14B has a total of four pass-through ports 114a arrayed in a 2×2 matrix. This also reads the structure that a large through hole is separated into four by providing beams vertically and horizontally. Such a first vaporized fuel plate having a plurality of pass-through ports (provided with beams) is advantageous in that a fuel cell having excellent strength against impact or the like is obtained because the rigidity in the in-plane direction is improved. Further, in comparison with the structure not having beams as shown in FIGS. 13A and 13B, it is also advantageous in that clogging of pass-through port by thermal expansion or the like of a member arranged above or below the first vaporized fuel plate is less likely to occur.

When the first vaporized fuel plate has two or more pass-through ports, as for the communication path provided in its peripheral part, the same number as that of the pass-through ports may be provided for each pass-through port, or a less number or a larger number of communication paths than the number of pass-through ports may be provided. In the example of FIGS. 14A and 14B, two communication paths 114b are provided for four pass-through ports 114a. In this way, there is no need to provide the communication path for each pass-through port, however, in such a case, as shown in FIG. 14A, the pass-through port that is not provided with a communication path 114b [lower two pass-through ports 114a in FIG. 14A] is spatially connected by a connection path 114c to the pass-through port that is provided with communication path 114b [upper two pass-through ports 114a in FIG. 14A]. Likewise communication path 114b, connection path 114c may be a groove (recess) provided in a beam between the pass-through ports [FIG. 14B]. By providing connection path 114c, it is possible to discharge the byproduct gas having entered the pass-through port that is not provided with communication path 114b outside through communication path 114b.

It is also preferred to provide a connection path 114d for spatially connecting pass-through ports that are provided with communication path 114b and/or pass-through ports that are not provided with communication path 114b in order to improve the efficiency of discharging the byproduct gas having reached the pass-through port (vaporized fuel accommodating portion) of the first vaporized fuel plate outside, or in order to improve the ability of the first vaporized fuel plate to uniformize the concentration of the fuel supplied to first anode electrode 102 [FIG. 14A].

The ratio S₁/S₀ between the section area of the communication path (a total section area when there are two or more communication paths) S₁, and the total area of lateral surfaces of the first vaporized fuel plate S₀ needs to be larger than 0 for discharging the byproduct gas and accompanying heat, and is preferably greater than or equal to 0.002. It is preferably less than 0.3, more preferably less than 0.1, and further preferably less than 0.05. When the ratio is greater than or equal to 0.3, leakage of liquid fuel and intrusion of air are more likely to occur, and stability of power generation can be impaired.

In the case where one or two or more communication paths are provided only in one peripheral part of the four peripheral parts contained in the first vaporized fuel plate, for example in the case where all communication paths are provided on a lateral surface that is opposed to the lateral surface of fuel cell to which fuel distribution portion 10 is conjoined, the ratio S₁/S₂ between the section area of the communication path (a total section area when there are two or more communication paths) S₁ and the section area of the lateral surface in the peripheral part where the communication path is provided S₂ is preferably greater than or equal to 0.008 for the same reason as described above.

Materials for the first vaporized fuel plate may be plastic, metal or non-porous carbon materials. Examples of plastic include polyphenylene sulfide (PPS), polyimide (PI), poly(methyl methacrylate) (PMMA), acrylonitrile butadiene styrene (ABS), polyvinyl chloride, polyethylene (PE), polyethylene terephthalate (PET), polyether ether ketone (PEEK), polytetrafluoroethylene (PTFE) and polyvinylidene fluoride (PVDF). Examples of metal include titanium and aluminum, as well as alloy materials such as stainless and magnesium alloys.

Among these, it is preferred that the first vaporized fuel plate is formed of a material having high rigidity such as metal, polyphenylene sulfide (PPS) or polyimide (PI). By using the first vaporized fuel plate having high rigidity, it becomes possible to join the first vaporized fuel plate and the member neighboring the same by hot press (thermal compression bonding), and thus it is possible to reduce the variations in thickness and power generating characteristics of the fuel cell. Also, it is possible to effectively prevent the communication path from being clogged at the time of hot pressing.

While the first vaporized fuel plate may be omitted, it is preferred to provide the first vaporized fuel plate for obtaining the aforementioned effect.

(First Gas-Liquid Separating Layer)

First gas-liquid separating layer 112 that is arranged between first membrane electrode assembly 104 and first flow channel plate 22a, on the surface of first intermediate layer 111 (which will be described later) on the side of first anode electrode 102 is a vaporized-fuel-permeable (the property that allows permeation of vaporized component of liquid fuel), liquid-fuel-impermeable porous layer having hydrophobicity, and is a layer having a gas-liquid separating ability that enables the vaporized fuel to be supplied to first anode electrode 102. First gas-liquid separating layer 112 has a function of controlling (restricting) the amount or concentration of vaporized fuel supplied to first anode electrode 102 to an appropriate amount, as well as uniformizing the same. By providing first gas-liquid separating layer 112, the crossover of the fuel can be repressed effectively, and temperature fluctuation is less likely to occur in first membrane electrode assembly 104, and a stable power generating condition can be kept.

First gas-liquid separating layer 112 is not particularly limited insofar as it has a gas-liquid separating ability for the fuel being used, and for example, porous films or porous sheets formed of fluorine based resins such as polytetrafluoroethylene (PTFE) and polyvinylidene fluoride, or water-repellent finished silicone resins are recited, and concretely, “NTF2026A-N06” or “NTF2122A-S06” of TEMISH (registered trade name) available from NITTO DENKO CORPORATION, which is a porous film formed of polytetrafluoroethylene can be exemplified.

From the view point of imparting the vaporized fuel permeability and liquid fuel impermeability, the maximum micropore diameter of micropores contained in first gas-liquid separating layer 112 is preferably 0.1 to 10 μm, and more preferably 0.5 to 5 μm. The maximum micropore diameter can be determined by measuring a bubble point using methanol or the like similarly to first intermediate layer 111 as will be described later. First gas-liquid separating layer 112 has a contact angle to water as will be described later of substantially greater than or equal to 80 degrees, and more typically greater than or equal to 90 degrees.

While thickness of first gas-liquid separating layer 112 is not particularly limited, it is preferably greater than or equal to 20 μm, and more preferably greater than or equal to 50 μm for sufficiently achieving the aforementioned function. Also from the view point of thinning the fuel cell, the thickness of first gas-liquid separating layer 112 is preferably less than or equal to 500 μm, and more preferably less than or equal to 300 μm.

(First Intermediate Layer)

First intermediate layer 111 arranged between first gas-liquid separating layer 112 and first flow channel plate 22a to cover the surface of first flow channel plate 22a on the side of first anode electrode 102 (therefore, the groove (recess) that forms first in-cell fuel flow channel 23) is preferably a hydrophilic layer having a contact angle to water of less than 70 degrees. By arranging such a layer in such a manner that it covers first in-cell fuel flow channel 23, the liquid fuel is drawn into first in-cell fuel flow channel 23 owing to the hydrophilicity of first intermediate layer 111, so that it is possible to reduce the pressure loss of the liquid fuel inside first in-cell fuel flow channel 23. As a result, fuel supply efficiency to first in-cell fuel flow channel 23 and diffusibility of liquid fuel in the plane of first flow channel plate 22a, and thus supply efficiency of vaporized fuel to first anode electrode 102 and uniformity of fuel supply in the plane of first anode electrode 102 can be further improved. The contact angle to water of first intermediate layer 111 is measured in conformance with JIS R 3257

### (Testing Method of Wettability of Glass Substrate).

First intermediate layer 111 preferably exhibits capillary action with respect to the liquid fuel, and more preferably exhibits relatively large capillary action so that it is able to reduce the pressure loss of liquid fuel in first in-cell fuel flow channel 23 more effectively. From such a point of view, first intermediate layer 111 preferably has micropores, and the maximum micropore diameter of micropores is preferably less than or equal to 1 μm, and more preferably less than or equal to 0.7 μm.

The maximum micropore diameter of first intermediate layer 111 may be obtained by measuring a bubble point as will be described later, and as other technique, it may be measured by a mercury intrusion technique. However, since the mercury intrusion technique can measure merely the micropores distributed in the range of 0.005 μm to 500 μm, it is an effective measuring means only when micropores outside this range do not exist or ignorable.

While not particularly limited, first intermediate layer 111 may have a bubble point of, for example, about greater than or equal to 5 kPa when methanol is used as a measurement medium. For imparting higher capillary force, a higher bubble point is preferred. From such a view point, the bubble point may be greater than or equal to 30 kPa, and may be greater than or equal to 50 kPa.

On the other hand, in an embodiment intended to make air bubbles generated in the liquid fuel in first in-cell fuel flow channel 23 or out-cell fuel flow channel 15 during power generation possible to escape to the side of vaporized fuel accommodating portion 113a via first intermediate layer 111 and first gas-liquid separating layer 112 and to be discharged outside the fuel cell, a lower bubble point of first intermediate layer 111 is preferred. In such an embodiment, hydrophilicity (surface wettability) of first intermediate layer 111 mainly contributes to reduction in pressure loss of liquid fuel inside first in-cell fuel flow channel 23.

Providing first intermediate layer 111 is also advantageous in that it is possible to effectively prevent the byproduct gas generated in first anode electrode 102 from entering inside first in-cell fuel flow channel 23 because the liquid fuel can be retained in first intermediate layer 111. The ability to prevent the byproduct gas generated in first anode electrode 102 from entering inside first in-cell fuel flow channel 23 means that the route for discharging the byproduct gas outside the fuel cell is limited to the discharge route through the communication path of first vaporized fuel plate 113, and hence, discharge of the byproduct gas and discharge of heat accompanying the same from the communication path can be promoted, and heat conduction to first in-cell fuel flow channel 23 can be effectively repressed. As a result, it is possible to repress the excessive temperature rise as the whole fuel cell including first in-cell fuel flow channel 23 and crossover and temperature runaway in association with this more effectively.

Bubble point is a minimum pressure at which generation of an air bubble is observed on the surface of a layer (membrane) when air pressure is applied from backside of the layer (membrane) wetted with a liquid medium. Bubble point ΔP is defined by the following formula (1):

ΔP [Pa]=4γ cos θ/d (1)

(γ represents a surface tension of the measurement medium [N/m], and θ represents a contact angle between the layer (membrane) material and the measurement medium, and d represents a maximum micropore diameter of the layer (membrane).). Bubble point is measured in conformance with JIS K 3832 using methanol as the measurement medium.

As first intermediate layer 111, for example, a porous layer formed of a polymer material, a metal material or an inorganic material, and a polymer film can be recited, and concrete examples are shown below.

(i) Porous layers formed of the following materials: fluorine based resins such as polyvinylidene fluoride (PVDF) and polytetrafluoroethylene (PTFE); acrylic resins; ABS resin; polyolefin based resins such as polyethylene and polypropylene; polyester based resins such as polyethylene terephthalate; cellulose based resins such as cellulose acetate, nitrocellulose and ion exchange cellulose; nylons; polycarbonate based resins; chlorinated resins such as polyvinyl chloride; polyetheretherketone; polyethersulfone; glass; ceramics; and metal materials such as stainless, titanium, tungsten, nickel, aluminum and steel. The porous layer may be a foam body, a sintered body, nonwoven fabric or fiber (glass fiber or the like) formed of these materials.

(ii) Polymer films formed of the following materials: those usable as materials for an electrolyte membrane material such as perfluorosulfonic acid based polymers; hydrocarbon polymers including styrene based graft polymers, trifluorostyrene derivative copolymers, sulfonated polyarylene ethers, sulfonated polyether ether ketones, sulfonated polyimides, sulfonated polybenzoimidazole, phosphonated polybenzoimidazole, sulfonated polyphosphazene and the like. These polymer films have micropores in the order of nanometer as gaps in the three-dimensionally tangling polymers.

Among the materials recited in the above, when a hydrophobic material is used as a base material, it is possible to adjust the contact angle to less than 70 degrees by conducting a hydrophilic surface treatment, for example, by introducing a hydrophilic functional group, to improve the wettability of the microporous surface with respect to water.

The thickness of first intermediate layer 111 is not particularly limited, however, from the view point of thinning of the fuel cell, it is preferably 20 to 500 μm, and more preferably 50 to 200 μm.

First fuel cell 20 may not have first intermediate layer 111. In this case, first gas-liquid separating layer 112 is stacked directly on the surface of first flow channel plate 22a on the side of first anode electrode 102 so that it covers first in-cell fuel flow channel 23. According to this configuration, even when air bubbles are generated from the dissolved gas in the liquid fuel by temperature rise at the time of power generation, these can be pushed out toward the side of vaporized fuel accommodating portion 113a, so that clogging of first in-cell fuel flow channel 23 by the air bubbles can be prevented. On the other hand, when first intermediate layer 111 is provided, it is preferred to use the one having a relatively low bubble point as described above, or to provide in the fuel cell with a path for discharging the air bubbles (for example, a path communicating the terminal of first in-cell fuel flow channel 23 and outside the fuel cell).

(First Cathode Moisturizing Layer and First Anode Moisturizing Layer)

First cathode moisturizing layer 108 is a layer that is optionally provided on first cathode electrode 103, preferably on first cathode collecting layer 106, for preventing the water generated in first cathode electrode 103 from evaporating outside the fuel cell from the side of first cathode electrode 103. By providing first cathode moisturizing layer 108, the water generated in first cathode electrode 103 can be effectively returned to first anode electrode 102 via first electrolyte membrane 101 without evaporating outside the fuel cell, and can be effectively used in the reaction in first anode electrode 102.

First anode moisturizing layer 107 is a layer that is optionally provided between first anode electrode 102 or first anode collecting layer 105, and vaporized fuel accommodating portion 113a, for preventing the water inside first anode electrode 102 from evaporating outside first membrane electrode assembly 104 (for example, toward vaporized fuel accommodating portion 113a) from the side of first anode electrode 102, and retaining it inside first anode electrode 102. By providing first anode moisturizing layer 107, it is possible to desirably retain inside first anode electrode 102 the water generated in first cathode electrode 103 and having reached first anode electrode 102 via first electrolyte membrane 101 while preventing it from evaporating outside first membrane electrode assembly 104. As a result, the water is effectively used in reactions in first anode electrode 102, so that the reaction efficiency in first anode electrode 102 increases, and high power generating characteristics can be exerted stably. In particular, by using first cathode moisturizing layer 108 together, the effect can be obtained more effectively.

Further, providing first cathode moisturizing layer 108 and first anode moisturizing layer 107 is effective for preventing drying of first electrolyte membrane 101, and increase in cell resistance and decrease in power generating characteristics in association with the same.

First cathode moisturizing layer 108 and first anode moisturizing layer 107 are formed of materials that have gas permeability to allow vaporized fuel or an oxidizing agent (such as air) from outside the fuel cell or the like to permeate therethrough, and are insoluble to water, and have moisturizing property (not allowing evaporation of water). Concrete examples include porous films (porous layers) of fluorine based resins such as polyvinylidene fluoride (PVDF) and polytetrafluoroethylene (PTFE); acrylic resins; polyolefin based resins such as polyethylene and polypropylene; polyester based resins such as polyethylene terephthalate; polyurethane based resins; polyamide based resins; polyacetal based resins; polycarbonate based resins; chlorinated resins such as polyvinyl chloride; polyether based resins; polyphenylene based resins; and water-repellent finished silicone resins. These moisturizing layers may be of a foam body, fiber bundle, woven fiber, nonwoven fiber or combination of these.

Since first cathode moisturizing layer 108 is desired to have gas permeability so as to allow permeation of the oxidizing agent (such as air) from outside the fuel cell, and have moisturizing property (not allowing evaporation of water), its porosity is preferably greater than or equal to 30% and less than or equal to 90%, and more preferably greater than or equal to 50% and less than or equal to 80%. When the porosity exceeds 90%, it can become difficult to retain the water generated in first cathode electrode 103 inside the fuel cell. On the other hand, when the porosity is less than 30%, diffusion of the oxidizing agent (such as air) from outside the fuel cell is inhibited, and the power generating characteristics in first cathode electrode 103 tends to decrease.

Since first anode moisturizing layer 107 is desired to have gas permeability so as to allow permeation of the vaporized fuel and the byproduct gas (such as CO₂ gas) generated in the catalyst layer, and have moisturizing property (not allowing evaporation of water), its porosity is preferably greater than or equal to 50% and less than or equal to 90%, and more preferably greater than or equal to 60% and less than or equal to 80%. When the porosity exceeds 90%, it can become difficult to retain the water generated in first cathode electrode 103 and having reached first anode electrode 102 via first electrolyte membrane 101, inside first membrane electrode assembly 104. On the other hand, when the porosity is less than 50%, diffusion of the vaporized fuel and the byproduct gas (such as CO₂ gas) generated in the catalyst layer is inhibited, and the power generating characteristics in first anode electrode 102 tends to decrease.

Porosities of first cathode moisturizing layer 108 and first anode moisturizing layer 107 may be determined by measuring the volume and the weight of the moisturizing layer, determining the specific gravity of the moisturizing layer, and calculating from this and the specific gravity of the material, according to the following formula (2):

Porosity (%)=[1−(specific gravity of moisturizing layer/specific gravity of material)]×100 (2)

Thicknesses of first cathode moisturizing layer 108 and first anode moisturizing layer 107 are not particularly limited, however, they are preferably greater than or equal to 20 μm, and more preferably greater than or equal to 50 μm for sufficiently realizing the aforementioned function. Further, from the view point of thinning of the fuel cell, they are preferably less than or equal to 500 μm, and more preferably less than or equal to 300 μm.

Since it is desired that first cathode moisturizing layer 108 and first anode moisturizing layer 107 have such a property that the layer itself has high water absorbability, and uptakes the liquid water having absorbed and does not release the same outside, they preferably have water repellency. From such a view point, these moisturizing layers are preferably porous films (porous layers) formed of fluorine based resins such as polyvinylidene fluoride (PVDF) and polytetrafluoroethylene (PTFE); or water-repellent finished silicone resins among those recited in the above. Concretely, “NTF2026A-N06” and “NTF2122A-S06” of TEMISH (registered trade name) available from NITTO DENKO CORPORATION, which are porous films formed of polytetrafluoroethylene are exemplified.

Preferably, first anode collecting layer 105 is arranged on first anode electrode 102, and first anode moisturizing layer 107 is stacked on first anode collecting layer 105 in contact with first anode collecting layer 105. As a result, it is possible to prevent water inside first anode electrode 102 from evaporating outside first membrane electrode assembly 104 more effectively.

First cathode moisturizing layer 108 and first anode moisturizing layer 107 are provided as necessary, and at least either of these may be omitted.

(Adjustment of Thickness-Wise Position of First in-Cell Fuel Flow Channel)

In the present embodiment, for satisfying the aforementioned relationship in total length, for example, as shown in FIG. 2 to FIG. 5, the thickness-wise position of first in-cell fuel flow channel 23 in first fuel supply portion 22 is sometimes adjusted, and this adjustment may be achieved by adjusting the thickness of first flow channel plate 22a relative to first in-cell fuel flow channel 23 having a predetermined depth, or adjusting thickness of first vaporized fuel plate 113, first gas-liquid separating layer 112 and/or first intermediate layer 111 stacked on first flow channel plate 22a (in some cases, omitting first vaporized fuel plate 113, first gas-liquid separating layer 112 and/or first intermediate layer 111).

(Type of Fuel Cell)

First fuel cell 20 (and second fuel cell 20′, and thus the fuel cell stack of the present invention) may be a polymer electrolyte fuel battery, or a direct alcohol type fuel battery using alcohol or an alcohol aqueous solution as liquid fuel, and is particularly preferred as a direct alcohol type fuel battery (in particular, direct methanol type fuel battery). As the liquid fuel, for example, alcohols such as methanol and ethanol; acetals such as dimethoxymethane; carboxylic acids such as formic acid; esters such as methyl formate; and aqueous solutions thereof can be recited. The liquid fuel is not limited to one kind, and may be a mixture of two or more kinds. In terms of low cost, high energy density per volume, and high power generating efficiency, a methanol aqueous solution or pure methanol is preferably used. As the oxidizing agent gas supplied to first cathode electrode, air or oxygen gas is preferred, and air is particularly preferred.

### [4] Second Fuel Cell

Second fuel cell 20′ includes, for example, likewise first fuel cell 20, a second membrane electrode assembly having a second anode electrode, a second electrolyte membrane and a second cathode electrode in this order; a second anode collecting layer stacked on the second anode electrode and electrically connected thereto; a second cathode collecting layer stacked on the second cathode electrode and electrically connected thereto; a second anode moisturizing layer stacked on the second anode collecting layer in contact with the second anode collecting layer; a second cathode moisturizing layer stacked on the second cathode collecting layer in contact with the second cathode collecting layer; a second flow channel plate arranged on the side of the second anode electrode, having second in-cell fuel flow channel 23′ for allowing liquid fuel to communicate (diffuse and communicate in a fuel cell surface); a second gas-liquid separating layer arranged between the second membrane electrode assembly and the second flow channel plate, allowing permeation of a vaporized component of liquid fuel; a second vaporized fuel plate arranged between the second gas-liquid separating layer and the second anode moisturizing layer, having a vaporized fuel accommodating portion; and a second intermediate layer arranged between the second gas-liquid separating layer and the second flow channel plate in such a manner that it covers second in-cell fuel flow channel 23′.

In this example, second power generation portion 21′ is made up of the second cathode moisturizing layer, the second cathode collecting layer, the second membrane electrode assembly, the second anode collecting layer and the second anode moisturizing layer, and second fuel supply portion 22′ is made up of the second vaporized fuel plate, the second gas-liquid separating layer, the second intermediate layer and the second flow channel plate.

For details of the members constituting second fuel cell 20′, reference is made to the foregoing description for the corresponding members constituting first fuel cell 20. The layer configuration of second fuel cell 20′ may be the same or different with/from that of first fuel cell 20. As to the adjustment of thickness-wise position of the second in-cell fuel flow channel and the type of fuel cell, reference is made to the foregoing description for first fuel cell 20.

### [5] Fuel Distribution Portion

As described above, fuel distribution portion 10 is a member independent of a fuel cell, having inlet 11 for introducing liquid fuel, and out-cell fuel flow channel 15 connecting inlet 11 and in-cell fuel flow channel 23, 23′ of each fuel cell 20, 20′ inside the same, for distributing and supplying liquid fuel to each fuel cell 20, 20′. In the example of FIG. 1, the number of inlet 11 is one, however, fuel distribution portion 10 may have plural inlets 11 (for example, providing one inlet per one set assuming the four fuel cells shown in FIG. 2 as one set) without limited to the above.

The outline shape of fuel distribution portion 10 is not particularly limited, and an appropriate shape is selected in consideration of the shape and area of the fuel cell storage space in the electric device to which the fuel cell stack is applied, and the number and the arrangement form of the fuel cells incorporated into the fuel cell stack. Fuel distribution portion 10 may be formed of various plastic materials, metal materials, alloy materials and so on.

Each fuel cell 20, 20′ and fuel distribution portion 10 may be conjoined by using a fastening member such as screw, bolt and nut or the like while packing or the like (double-faced tape or the like) is interposed in the contact part thereof as is necessary.

### [6] Modified Examples

The fuel cell stack of the present embodiment (ditto for the second embodiment as will be described later) embraces the following modified examples as well as the examples and modified examples described above.

(i) The number of fuel cells contained in the fuel cell stack is not particularly limited, and it suffices that at least one first fuel cell 20 and one second fuel cell 20′ arranged above the main surface of first fuel cell 20 (namely, at least two fuel cells stacked thickness-wise) are contained.

(ii) In the case where the fuel cell stack includes a fuel cell assembly made up of two or more fuel cells arranged on the same plane, the two or more fuel cells are not necessarily arranged in line. However, from the view point of improving the integrated rate of the fuel cell, reducing the area occupied by the fuel cell stack, simplifying the structure of the fuel distribution portion, and ensuring a straight supply path for the oxidizing agent (such as air), they are preferably arranged in line.

(iii) Second fuel cell 20′ arranged above the main surface of first fuel cell 20 is not necessarily arranged directly above (arranged to face) first fuel cell 20, however, from the view point of reducing the area occupied by the fuel cell stack, and facilitating formation of fuel flow channel satisfying the aforementioned relationship in total length, it is preferably arranged to face first fuel cell 20.

(iv) In the example of FIG. 2 and the like, first and second branched flow channels 19a, 19b include a flow channel part that extends substantially perpendicularly to the main surface of first fuel cell 20 (and second fuel cell 20′), however, it may be a diagonal flow channel that directly extends to inlet ends of first and second in-cell fuel flow channels 23, 23′ from end part 16A without limited to the above. In this case, out-cell fuel flow channel 15 does not have second main flow channel 17.

(v) When the fuel cell stack includes two or more sets of fuel cells, each set including one first fuel cell 20 and one second fuel cell 20′ arranged above the main surface of first fuel cell 20, in the present embodiment, it suffices that at least one set satisfies the aforementioned relationship in total length, and referring to FIG. 2 for example, first fuel cell 20a in the right set and second fuel cell 20′ in the left set does not necessarily satisfy the aforementioned relationship in total length. However, in consideration of uniformizing liquid fuel supply to every fuel cell contained in the fuel cell stack, it is preferred that the aforementioned relationship in total length is satisfied between every first fuel cell 20 and every second fuel cell 20′.

(vi) While the distance (width of space 30) between first fuel cell 20 and second fuel cell 20′ arranged above the main surface of first fuel cell 20 is not particularly limited, however, in consideration of the supply efficiency of the oxidizing agent to a cathode electrode of each fuel cell, it is preferably 0.5 to 5.0 mm.

(vii) In the case where the fuel cell stack includes two or more fuel cells arranged in line on the same plane, these fuel cells may be arranged so that a gap is formed between the neighboring fuel cells as shown in FIG. 1, or may be arranged with no gap as shown in FIG. 15. The former configuration (configuration in FIG. 1) is advantageous because air can be taken in through the gap, for example, when air is used as the oxidizing agent, and the atmospheric air of the fuel cell stack is taken by natural convection without using an auxiliary machine such as a blowing fan or a blower. The latter configuration (configuration in FIG. 15) is advantageous because the oxidizing agent can be securely flown in space 30 when the oxidizing agent such as air is fed from the lateral surface of the fuel cell stack using an auxiliary machine as described above.

<Fuel Cell System>

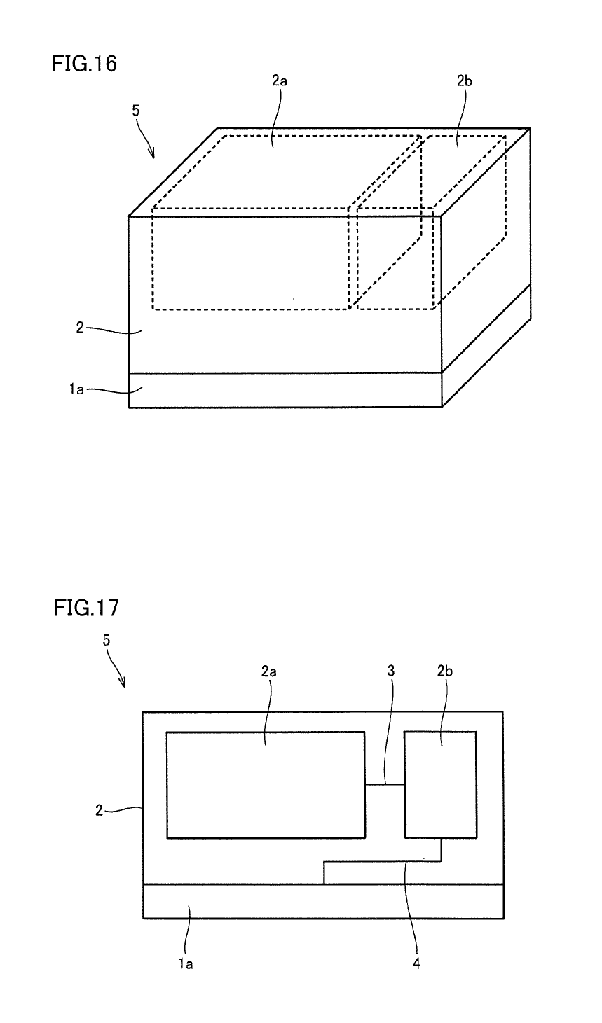

The fuel cell stack according to the present embodiment as described above may be added with a fuel tank for storing liquid fuel, to configure a fuel cell system. FIG. 16 and FIG. 17 are respectively a schematic perspective view and a schematic section view showing one example of the fuel cell system.

Fuel cell system 5 shown in FIG. 16 and FIG. 17 includes fuel cell stack 1a according to the present embodiment as described above, and a liquid sending unit (liquid sending portion) 2 for sending liquid fuel to fuel cell stack 1a. Liquid sending unit 2 includes at least a fuel tank 2a for accommodating liquid fuel, connected to inlet 11 of fuel distribution portion 10 contained in fuel cell stack 1a, and includes a liquid sending means 2b such as a liquid sending pump for promoting flow of liquid fuel from fuel tank 2a to inlet 11 as is necessary. When liquid sending means 2b is included, for example, liquid sending unit 2 may be such a configuration that fuel tank 2a and liquid sending means 2b are connected by a first liquid sending path 3, and liquid sending means 2b and inlet 11 of fuel distribution portion 10 are connected by a second liquid sending path 4.

### Second Embodiment

### Fuel Cell Stack

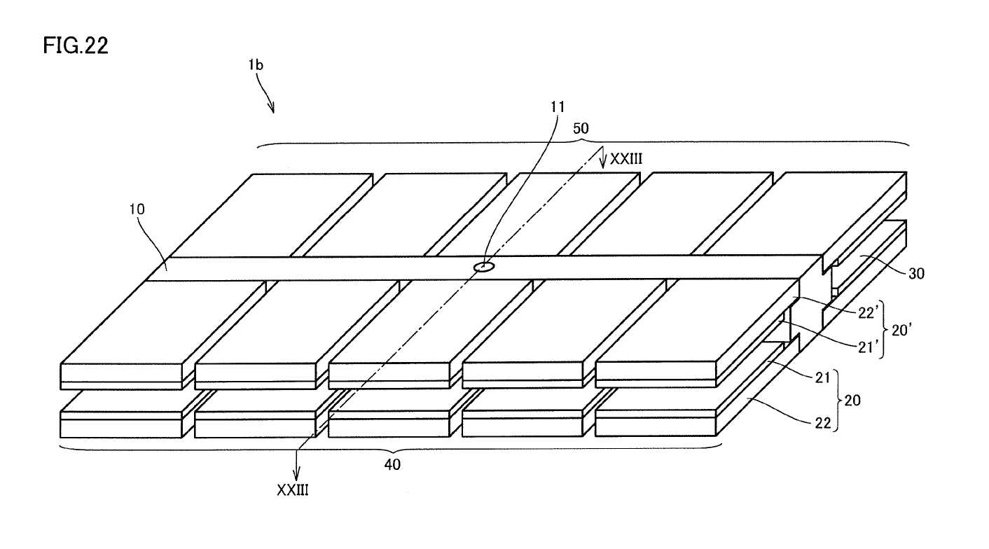

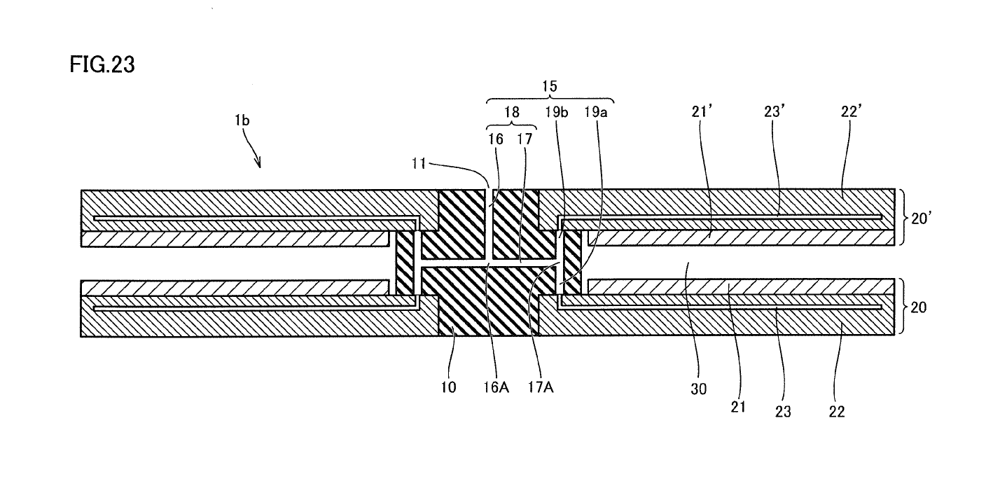

FIG. 22 is a schematic perspective view showing one example of a fuel cell stack according to the present embodiment, and FIG. 23 is a schematic section view along the line XXIII-XXIII shown in FIG. 22. In FIGS. 22 to 30, the element having the same name as the element constituting fuel cell stack 1a according to the first embodiment is denoted by the same reference numeral as that used for fuel cell stack 1a.

As shown in FIG. 22, fuel cell stack 1b shown in these drawings has the same overall structure as fuel cell stack 1a according to the first embodiment. Therefore, for the overall structure of fuel cell stack 1b, reference is made to the foregoing description about fuel cell stack 1a according to the first embodiment.

### [1] Structure of Fuel Flow Channel

Also in fuel cell stack 1b, likewise fuel cell stack 1a described above, the fuel flow channel includes in-cell fuel flow channels contained in each fuel cell (first and second in-cell fuel flow channels 23, 23′), and out-cell fuel flow channel 15 provided in fuel distribution portion 10, connected to first and second in-cell fuel flow channels 23, 23′. Similarly to fuel cell stack 1a described above, fuel cell stack 1b has one first main flow channel 16, a total of 10 second main flow channels 17, one third main flow channel, and a total of 10 first branched flow channels 19a and a total of 10 second branched flow channels 19b.

In fuel cell stack 1b, the fuel flow channel is so configured that by making the section area of out-cell fuel flow channel 15 larger than those of first and second in-cell fuel flow channels 23, 23′, and thereby making section area of out-cell fuel flow channel 15 in the connection part between first and second in-cell fuel flow channels 23, 23′ and out-cell fuel flow channel 15 larger than the section areas of first and second in-cell fuel flow channels 23, 23′, the pressure loss of the liquid fuel flowing from inlet 11 to first and second in-cell fuel flow channels 23, 23′ via out-cell fuel flow channel 15 increases at the connection part. In the example of FIG. 23, respective section areas of out-cell fuel flow channel 15, and first and second in-cell fuel flow channels 23, 23′ are entirely constant, but they are not limited to this.

According to fuel cell stack 1b that satisfies the aforementioned relationship in section area, and thus the relationship in pressure loss, liquid fuel is supplied to each in-cell fuel flow channel 23, 23′ after in-cell fuel flow channel 15 is filled entirely with the liquid fuel, so that it is possible to supply the liquid fuel uniformly to first fuel cell 20 and second fuel cell 20′ that are stacked thickness-wise although the fuel flow channel includes first and second branched flow channels 19a, 19b extending substantially perpendicularly to the main surface of first fuel cell 20 (and second fuel cell 20′).

The section area of out-cell fuel flow channel 15 may be, for example, within the range of 100 μm² to 1 mm², and the section areas of first and second in-cell fuel flow channels 23, 23′ each may be, for example, within the range of 2500 μm² to 10000 μm². The section area of first in-cell fuel flow channel 23 and the section area of second in-cell fuel flow channel 23′ may be the same or different, and they are preferably the same in order to further increase the uniformity of fuel supply to first fuel cell 20 and second fuel cell 20′.

As in the foregoing example, the fuel cell stack of the present embodiment includes a fuel flow channel configured in such a manner that pressure loss of the liquid fuel that flows from inlet 11 to first and second in-cell fuel flow channels 23, 23′ via out-cell fuel flow channel 15 increases at a certain point, and the means for satisfying such a relationship in pressure loss is not limited to that exemplified in FIG. 23.

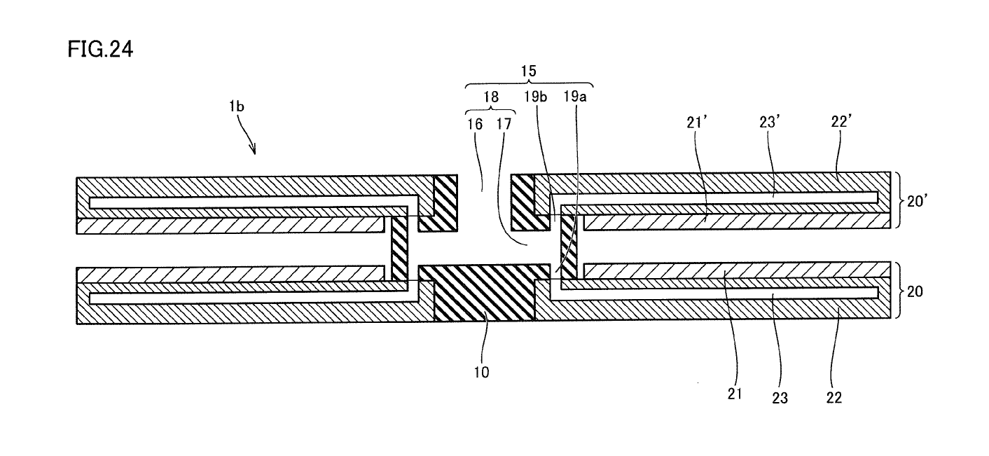

For example, the aforementioned “certain point” is not limited to the connection part between first and second in-cell fuel flow channels 23, 23′ and out-cell fuel flow channel 15, and may be the vicinity thereof as shown in the example of FIG. 24 (for example, in the vicinity of the connection part in out-cell fuel flow channel 15). When the pressure loss change point is provided at a position far from the connection part, nonuniformity of fuel supply can occur on the way to first and second in-cell fuel flow channels 23, 23′ from the pressure loss change point.

In the example of FIG. 24, the aforementioned relationship in pressure loss is satisfied by making the section area of second main flow channel 17 larger than the section areas of first and second branched flow channels 19a, 19b, thereby making the section area of the fuel flow channel part on the side of inlet 11 based on the connection part (namely, main flow channel 18) in the connection part between second main flow channel 17 and first and second branched flow channels 19a, 19b (the connection part is in the vicinity of the connection part between first and second in-cell fuel flow channels 23, 23′ and out-cell fuel flow channel 15), larger than the section area of the remaining fuel flow channel part (namely, first and second branched flow channels 19a, 19b, and in-cell fuel flow channels 23, 23′). In the example of FIG. 24, the section areas of first and second in-cell fuel flow channels 23, 23′ and the section area of out-cell fuel flow channel 15 are identical in the connection part between first and second in-cell fuel flow channels 23, 23′ and out-cell fuel flow channel 15.

As described above, for satisfying the aforementioned relationship in pressure loss, at least at or in the vicinity of the connection part between first and second in-cell fuel flow channels 23, 23′ and out-cell fuel flow channel 15, the section area of the fuel flow channel part on the side of inlet 11 based on the connection part or in the vicinity thereof should be larger than the section area of the remaining fuel flow channel part. In such a configuration, the point at which the section area changes is a pressure loss change point, and liquid fuel is supplied to each in-cell fuel flow channel 23, 23′ after every fuel flow channel up to the pressure loss change point is filled with the liquid fuel, so that it becomes possible to supply the liquid fuel uniformly to first fuel cell 20 and second fuel cell 20′ stacked thickness-wise.

When the section area of first main flow channel 16 is made further larger than the section area of second main flow channel 17 as shown in the example of FIG. 24, a liquid sending means of low discharge pressure, and hence of small size can be used in introducing the liquid fuel into inlet 11 by using a liquid sending means such as a liquid sending pump. This is advantageous in the aspect of miniaturization of the fuel cell system.

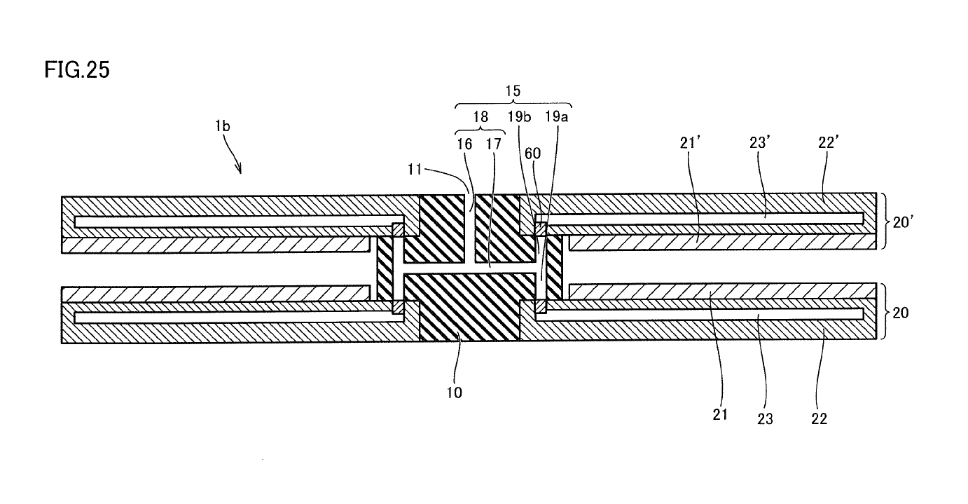

Further, for satisfying the aforementioned relationship in pressure loss, as shown in FIG. 25, at or in the vicinity of the connection part between first and second in-cell fuel flow channels 23, 23′ and out-cell fuel flow channel 15, the fuel flow channel may be charged with a porous body 60. The section area of fuel flow channel can be adjusted also by charging such porous body 60, rather than adjusting the width or depth of the fuel flow channel. That is, by charging porous body 60, it is possible to make the section area of the fuel flow channel part on the side of inlet 11 based on the position where porous body 60 is charged, larger than the section area of the remaining fuel flow channel part (including porous body 60).

Porous body 60 is formed of a material that is insoluble to liquid fuel. Concrete examples include cellulose; polyolefin based resins such as polyethylene and polypropylene; fluorine based resins such as polyvinylidene fluoride (PVDF) and polytetrafluoroethylene (PTFE); acrylic resins; polyester based resins such as polyethylene terephthalate; polyurethane based resins; polyamide based resins; polyacetal based resins; polycarbonate based resins; chlorinated resins such as polyvinyl chloride; polyether based resins; and polyphenylene based resins, and the one formed into a stretched porous body, a foam body, fiber bundle, woven fiber, nonwoven fiber from the material selected from these can be used as porous body 60.

Further, in other exemplary means for satisfying the relationship in pressure loss, at least at the connection part between first and second in-cell fuel flow channels 23, 23′ and out-cell fuel flow channel 15, or in the vicinity of the same, hydrophilicity (wettability) of the inner wall surface of the fuel flow channel part on the side of inlet 11 based on the connection part or its vicinity is made larger than the hydrophilicity (wettability) of the inner wall surface of the remaining fuel flow channel part. Also by such adjustment of hydrophilicity of the inner wall surface of the fuel flow channel, the point where the hydrophilicity changes becomes a pressure loss change point, and after the entire fuel flow channel up to the pressure loss change point is filled with the liquid fuel, the liquid fuel is supplied to each in-cell fuel flow channel 23, 23′, so that it is possible to supply the liquid fuel uniformly to first fuel cell 20 and second fuel cell 20′ stacked thickness-wise.

The shape of out-cell fuel flow channel 15 is not limited to that shown in FIG. 23, and can assume various shapes, however, it typically has main flow channel 18 through which the liquid fuel to be distributed and supplied to first fuel cell 20 and second fuel cell 20′ flow commonly, and first and second branched flow channels 19a, 19b branching from main flow channel 18. Also main flow channel 18 can assume various shapes without limited to the one shown in FIG. 23 including first main flow channel 16 extending substantially perpendicularly to the main surface of first fuel cell 20 and second main flow channel 17 extending substantially parallel with the main surface of first fuel cell 20.

Further, in the example as shown in FIG. 23 and so on, first and second branched flow channels 19a, 19b include flow channel parts extending substantially perpendicularly to the main surfaces of first fuel cell 20 (and second fuel cell 20′), however, they may be diagonal flow channels directly extending from end part 16A to inlet ends of first and second in-cell fuel flow channels 23, 23′ without limited to the above. In this case, out-cell fuel flow channel 15 does not have second main flow channel 17.

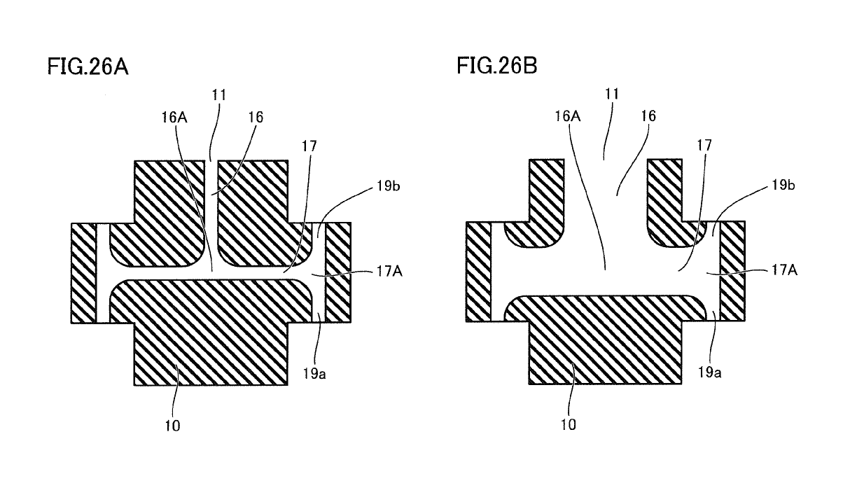

As shown in FIGS. 26A and 26B, it is also preferred to apply roundness (to form a corner by curved surface) to the branched parts of flow channel in out-cell fuel flow channel 15 (for example, end parts 16A, 17A). As a result, it is possible to decrease the variation in pressure loss of the liquid fuel in the branched parts, so that it is possible to supply fuel to first fuel cell 20 and second fuel cell 20′ stacked thickness-wise more uniformly. FIG. 26A shows an example in which roundness is applied to out-cell fuel flow channel 15 shown in FIG. 23, and FIG. 26B shows an example in which roundness is applied to out-cell fuel flow channel 15 shown in FIG. 24.

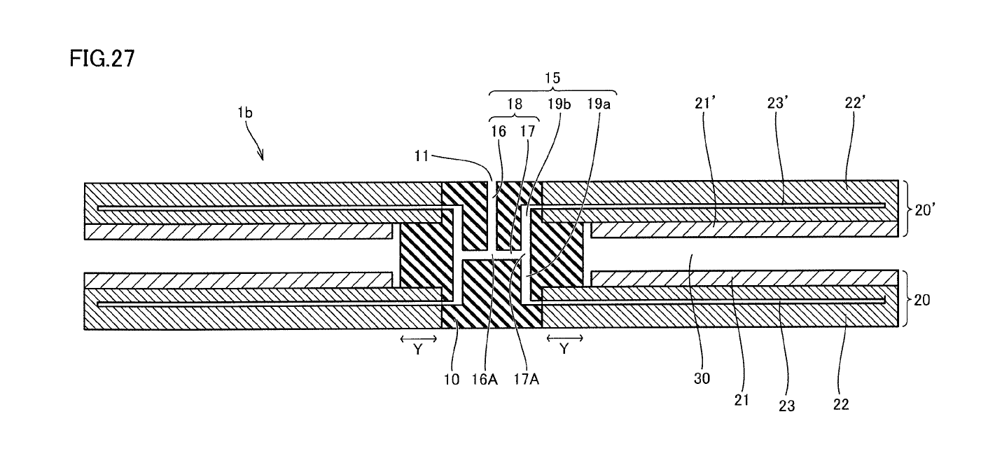

In examples of FIG. 23 to FIG. 25, first branched flow channel 19a and first in-cell fuel flow channel 23, and second branched flow channel 19b and second in-cell fuel flow channel 23′ are connected respectively in such a manner that they form flow channels extending substantially perpendicularly to the main surfaces of first fuel cell 20 and second fuel cell 20′ in their connection parts, however the connecting manner is not limited to these. For example, as shown in FIG. 27, first branched flow channel 19a and first in-cell fuel flow channel 23, and second branched flow channel 19b and second in-cell fuel flow channel 23′ may be connected respectively in such a manner that they form flow channels extending substantially parallel with the main surfaces of first fuel cell 20 and second fuel cell 20′ in their connection parts. In this case, first and second branched flow channels 19a, 19b may be, for example, substantially L-shaped flow channels each made up of a flow channel part extending substantially perpendicularly to the main surface of fuel cell and a flow channel part extending substantially parallel with the main surface of fuel cell, and first and second in-cell fuel flow channels 23, 23′ may be flow channels extending substantially parallel with the main surface of fuel cell.

The fuel flow channel structure shown in FIG. 27 is an example in which in the vicinity of the connection part between first and second in-cell fuel flow channels 23, 23′ and out-cell fuel flow channel 15, the section area of the fuel flow channel part on the side of inlet 11 based on the connection part is made larger than the section area of the remaining fuel flow channel part as is the case with FIG. 24.

In the fuel flow channel structure as shown in FIG. 27, a part of fuel distribution portion 10 [the region denoted by Y in FIG. 27] may be omitted or the width of the region may be reduced, so that the width of the fuel cell and thus the width of the fuel cell stack can be advantageously reduced.

### [2] First Fuel Cell

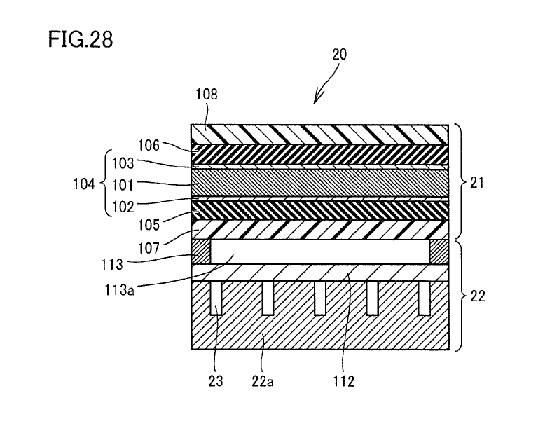

FIG. 28 is a schematic section view showing one example of layer configuration of first fuel cell 20 used in fuel cell stack 1b, and shows the cross section in the direction perpendicular to the cross section shown in FIG. 23. In the example shown in FIG. 28, first fuel cell 20 includes first membrane electrode assembly 104 having first anode electrode 102, first electrolyte membrane 101 and first cathode electrode 103 in this order; first anode collecting layer 105 stacked on first anode electrode 102 and electrically connected thereto; first cathode collecting layer 106 stacked on first cathode electrode 103 and electrically connected thereto; first anode moisturizing layer 107 stacked on first anode collecting layer 105 in contact with first anode collecting layer 105; first cathode moisturizing layer 108 stacked on first cathode collecting layer 106 in contact with first cathode collecting layer 106; first flow channel plate 22a arranged on the side of first anode electrode 102, having first in-cell fuel flow channel 23 for allowing liquid fuel to communicate (diffuse and communicate in a fuel cell surface); first gas-liquid separating layer 112 allowing permeation of a vaporized component of liquid fuel, directly stacked on the surface on the side of first anode electrode 102 of first flow channel plate 22a, and arranged between first membrane electrode assembly 104 and first flow channel plate 22a so as to cover first in-cell fuel flow channel 23; and first vaporized fuel plate 113 arranged between first gas-liquid separating layer 112 and first anode moisturizing layer 107, having vaporized fuel accommodating portion 113a.

In other words, first fuel cell 20 shown in FIG. 28 has a configuration similar to that of the first fuel cell shown in FIG. 9 except that it does not have first intermediate layer 111.

In the example shown in FIG. 28, first power generation portion 21 is made up of first cathode moisturizing layer 108, first cathode collecting layer 106, first membrane electrode assembly 104, first anode collecting layer 105 and first anode moisturizing layer 107, and first fuel supply portion 22 is made up of first vaporized fuel plate 113, first gas-liquid separating layer 112 and first flow channel plate 22a.

By providing first gas-liquid separating layer 112, and forming one surface of the inner wall of first in-cell fuel flow channel 23 from first gas-liquid separating layer 112, the pressure loss of liquid fuel in first in-cell fuel flow channel 23 is increased, so that the aforementioned relationship in pressure loss can be more easily satisfied.

First electrolyte membrane 101, first anode electrode 102 and first cathode electrode 103, first anode collecting layer 105, first cathode collecting layer 106, first flow channel plate 22a, first vaporized fuel plate 113, first gas-liquid separating layer 112, first cathode moisturizing layer 108, first anode moisturizing layer 107, and the type of first fuel cell may be similar to those described in the first embodiment, and reference is made to description for fuel cell stack 1a.

### [3] Second Fuel Cell and Fuel Distribution Portion

Similarly to first fuel cell 20, second fuel cell 20′ may include a second membrane electrode assembly having a second anode electrode, a second electrolyte membrane and a second cathode electrode in this order; a second anode collecting layer stacked on the second anode electrode and electrically connected thereto; a second cathode collecting layer stacked on the second cathode electrode and electrically connected thereto; a second anode moisturizing layer stacked on the second anode collecting layer in contact with the second anode collecting layer; a second cathode moisturizing layer stacked on the second cathode collecting layer in contact with the second cathode collecting layer; a second flow channel plate arranged on the side of the second anode electrode, having second in-cell fuel flow channel 23′ for allowing liquid fuel to communicate (diffuse and communicate in a fuel cell surface); a second gas-liquid separating layer allowing permeation of a vaporized component of liquid fuel, arranged on the surface of the second flow channel plate between the second membrane electrode assembly and the second flow channel plate so as to cover first in-cell fuel flow channel 23′; and a second vaporized fuel plate having a vaporized fuel accommodating portion arranged between the second gas-liquid separating layer and the second anode moisturizing layer.

In this example, second power generation portion 21′ is made up of the second cathode moisturizing layer, the second cathode collecting layer, the second membrane electrode assembly, the second anode collecting layer and the second anode moisturizing layer, and second fuel supply portion 22′ is made up of the second vaporized fuel plate, the second gas-liquid separating layer and the second flow channel plate.

As to the details of the members constituting second fuel cell 20′, reference will be made to the description for the corresponding member constituting the first fuel cell of fuel cell stack 1a according to the first embodiment. The layer configuration of second fuel cell 20′ may be the same or different with/from that of first fuel cell 20. Also as to the type of fuel cell, reference will be made to the description about the first fuel cell of fuel cell stack 1a according to the first embodiment.

As to fuel distribution portion 10, reference is made to the description about the fuel distribution portion of fuel cell stack 1a according to the first embodiment.

In the fuel cell stack of the present embodiment, as shown, for example, in FIG. 23 to FIG. 25, first fuel cell 20 and second fuel cell 20′ arranged on the main surface of the same (arranged to face each other) may be arranged so that the cathode electrode sides thereof face each other, or may be arranged at a distance so that the cathode electrode side of either one fuel cell and the side of the fuel supply portion of the other fuel cell face each other, namely the side of the first cathode electrode and the side of the second fuel supply portion face each other, or the side of the second cathode electrode and the side of the first fuel supply portion face each other.

Arranging so that the sides of the cathode electrodes face each other is advantageous, for example, in that the thickness of the thickest part of the fuel cell stack can be reduced, and the oxidizing agent supply path for first fuel cell 20 and the oxidizing agent supply path for second fuel cell 20′ can be made common (in other words, space 30 in FIG. 23 and the like is a common oxidizing agent supply path).

<Fuel Cell Stack Composite>

In the present invention, the term “fuel cell stack composite” involves the first fuel cell stack and the second fuel cell stack arranged on the main surface of the same, and in other words, means a plurality of fuel cell stacks stacked thickness-wise. A fuel cell stack composite may include three or more fuel cell stacks.

As the first and second fuel cell stacks, the fuel cell stacks according to the present embodiment described above are used. The first fuel cell stack and the second fuel cell stack may be stacked in contact with each other, or may be arranged with a space provided therebetween (distanced from each other).

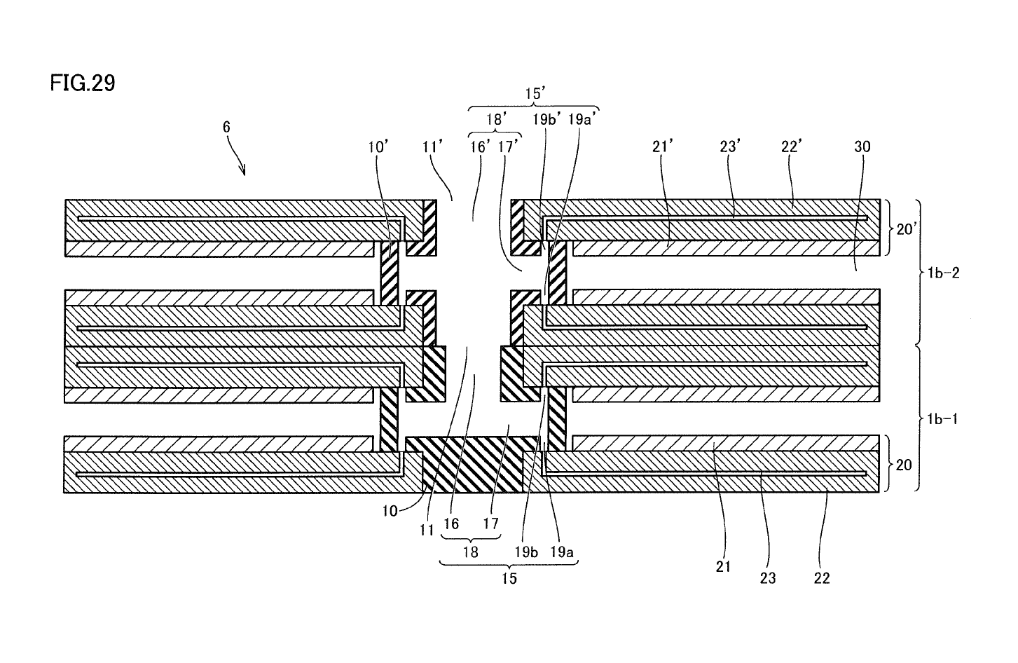

FIG. 29 is a schematic perspective view showing one example of a fuel cell stack composite according to the present invention. A fuel cell stack composite 6 shown in FIG. 29 includes a first fuel cell stack 1b-1; and a second fuel cell stack 1b-2 stacked in contact with the main surface of the same. Both of first and second fuel cell stacks 1b-1 and 1b-2 have a fuel flow channel structure similar to that in FIG. 24 (reference numerals 10′, 11′, 16′ to 18′, 19a′ and 19b′ are respectively the same meanings as 10, 11, 16 to 18, 19a and 19b), however, in fuel distribution portion 10′ of second fuel cell stack 1b-2, first main flow channel 16′ extends to inlet 11 of first fuel cell stack 1b-1, and out-cell fuel flow channel 15 of first fuel cell stack 1b-1 and out-cell fuel flow channel 15′ of second fuel cell stack 1b-2 communicate with each other. As a result, it becomes possible to supply fuel to every fuel cell contained in the fuel cell stack composite by providing liquid fuel from inlet 11′.

When plural fuel cell stacks are stacked thickness-wise as described above, it is preferred that in the connection part of their out-cell fuel flow channels, the section area of the out-cell fuel flow channel (out-cell fuel flow channel 15′) of the upper fuel cell stack (second fuel cell stack 1b-2) is larger than the section area of the out-cell fuel flow channel (out-cell fuel flow channel 15) of the lower fuel cell stack (first fuel cell stack 1b-1). As a result, not only fuel supply to first fuel cell 20 and second fuel cell 20′ that are arranged to face each other in each fuel cell stack is uniformized as a result of satisfying the aforementioned relationship in pressure loss, but also fuel supply to first fuel cell stack 1b-1 and second fuel cell stack 1b-2 is uniformized, so that uniform fuel supply to every fuel cell contained in the fuel cell stack composite is enabled.

The fuel flow channel structure shown in FIG. 29 is merely one example, and it can assume various shapes (for example, the shape shown in FIG. 23, FIG. 25 or FIG. 27) as far as the predetermined relationship in pressure loss is satisfied as described above.

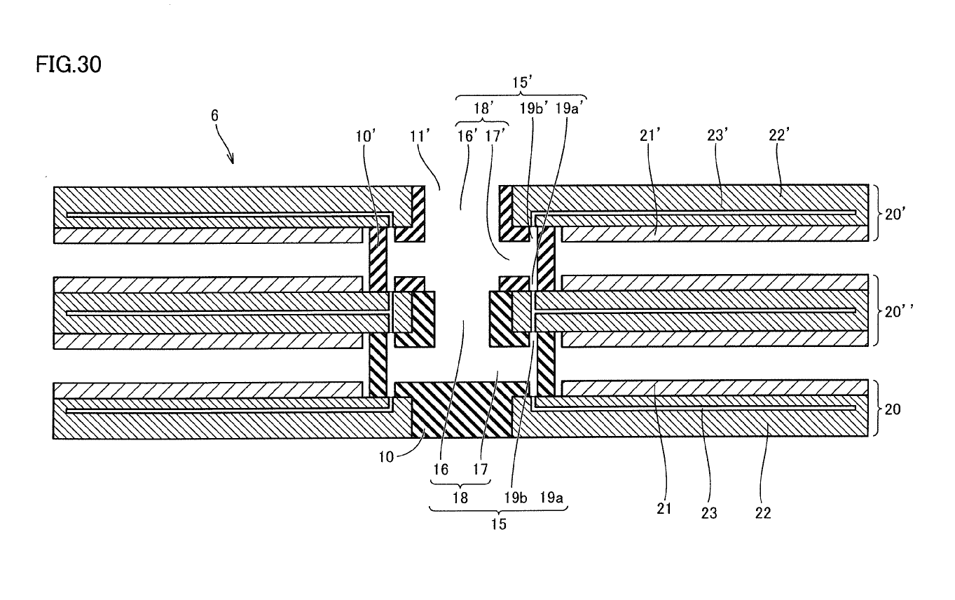

When first fuel cell stack 1b-1 and second fuel cell stack 1b-2 are stacked in contact with each other, neighboring first fuel supply portion 22 and second fuel supply portion 22′ may be integrated and formed from a single member. In this case, the integrated fuel supply portion may have both first in-cell fuel flow channel 23 and second in-cell fuel flow channel 23′, or as is the case with a third fuel cell 20″ shown in FIG. 30, first in-cell fuel flow channel 23 and second in-cell fuel flow channel 23′ may be integrated, and only one out-cell fuel flow channel may be included. In particular, the latter case is advantageous in thinning the fuel cell stack composite.

<Fuel Cell System>

Similarly to the first embodiment, the fuel cell stack and the fuel cell stack composite according to the present embodiment may be additionally provided with a fuel tank or the like for accommodating liquid fuel to form a fuel cell system as shown, for example, in FIG. 16 and FIG. 17. For details of the fuel cell system, reference is made to the description about the first embodiment.

When a fuel cell stack composite, for example, fuel cell stack composite 6 shown in FIG. 29 is used in place of fuel cell stack 1b, fuel tank 2a (or second liquid sending path 4) is connected to inlet 11′ of second fuel cell stack 1b-2.

The fuel cell stack, fuel cell stack composite and fuel cell system of the present invention can be suitably used as a power source for electronic devices, in particular for miniaturized electronic devices such as portable devices represented by portable phone, electronic organizer and notebook computer.

### EXAMPLES

In the following, the present invention will be described more specifically by way of examples, however, it is to be noted that the present invention is not limited to these examples.

### Example 1

A fuel cell stack having the configuration shown in FIG. 1 and a fuel cell system containing the same were fabricated in the following manner. The structure of fuel flow channel contained in the fuel cell stack is as shown in FIG. 2, and layer configuration of first and second fuel cells 20, 20′ is as shown in FIG. 9.

(1) Fabrication of Membrane Electrode Assembly

Catalyst-carrying carbon particles carrying 32.5% by weight of Pt and 16.9% by weight of Ru (TEC66E50, available from Tanaka Kikinzoku) and 20% by weight of an alcohol solution of Nafion (registered trade name) which is an electrolyte (available from Aldrich), n-propanol, isopropanol, and zirconia ball were put into a vessel formed of fluorine based resin in predetermined proportions, and mixed at 500 rpm for 50 minutes by using a stirrer, to prepare a catalyst paste for anode electrode. Also, a catalyst paste for cathode electrode was prepared in a similar way for the case of the catalyst paste for anode electrode expect that catalyst-carrying carbon particles carrying 46.8% by weight of Pt (TEC10E50E, available from Tanaka Kikinzoku) was used.

Then after cutting carbon paper formed with a porous layer having water repellency on either surface (25BC, available from SGL) into a piece of 35 mm long and 40 mm wide, the catalyst paste for anode electrode was applied on the porous layer so that the catalyst carrying amount was about 3 mg/cm² using a screen printing plate having a window of 30 mm long and 35 mm wide, and dried to fabricate an anode electrode having a thickness of about 300 μm where an anode catalyst layer is formed in the center on the carbon paper which is an anode conductive porous layer. On the other hand, on a porous layer of carbon paper of the same size, the catalyst paste for cathode electrode was applied so that the catalyst carrying amount was about 1 mg/cm² using a screen printing plate having a window of 30 mm long and 35 mm wide, and dried to fabricate a cathode electrode having a thickness of about 270 μm where a cathode catalyst layer is formed in the center on the carbon paper which is a cathode conductive porous layer.

Next, perfluorosulfonic acid based ion exchange membrane having a thickness of about 175 μm (Nafion (registered trade name) 117, available from Du Pont) was cut into a piece of 35 mm long and 40 mm wide to give an electrolyte membrane, and the anode electrode, the electrolyte membrane and the cathode electrode were laminated in this order so that the respective catalyst layers faced the electrolyte membrane, and then thermal compression bonded at 130° C. for 2 minutes, to join the anode electrode and the cathode electrode to the electrolyte membrane. The lamination was conducted so that the positions of the anode electrode and the cathode electrode on the plane of the electrolyte membrane coincide with each other and the centers of the anode electrode, the electrolyte membrane and the cathode electrode coincide with each other. Then by cutting the outer circumferential part of the obtained laminate, a membrane electrode assembly (MEA) of 22 mm long and 26 mm wide was fabricated.

(2) Stacking of Collecting Layer

A stainless plate (NSS445M2, available from NISSHIN STEEL CO., LTD) of 26.5 mm long, 27 mm wide and 0.1 mm thick was prepared, and its center region was formed with a plurality of through-holes penetrating thickness-wise by processing a plurality of openings having an opening diameter of φ 0.6 mm (opening pattern: zigzag 60° pitch 0.8 mm) from both sides by wet etching using a photoresist mask, and two such stainless plates were fabricated and provided as an anode collecting layer and a cathode collecting layer, respectively.

Then, the anode collecting layer was stacked on the anode electrode with a conductive adhesive layer formed of carbon particles and epoxy resin interposed therebetween, and the cathode collecting layer was stacked on the cathode electrode with the same conductive adhesive layer interposed therebetween, and these were joined by thermal compression bonding, to fabricate a MEA-collecting layer laminate.

(3) Joining of Moisturizing Layer

As an anode moisturizing layer and a cathode moisturizing layer, two porous films formed of polytetrafluoroethylene (“TEMISH (registered trade name) NTF2122A-S06” available from NITTO DENKO CORPORATION, 22 mm long, 26 mm wide, 0.2 mm thick, porosity 75%)) were prepared. These moisturizing layers were stacked on the anode collecting layer and the cathode collecting layer of the MEA-collecting layer laminate with an adhesive layer of polyolefin interposed therebetween, and these were joined by thermal compression bonding. These moisturizing layers were joined so that they were arranged directly above or directly below the MEA.

(4) Joining Between Intermediate Layer and Gas-Liquid Separating Layer

As an intermediate layer, a porous film formed of polyvinyl fluoride of 26.5 mm long, 27 mm wide and 0.1 mm thick (Durapore membrane filter available from MILLIPORE) was used. The contact angle to water of this porous film was less than 70 degrees. The maximum micropore diameter of micropores contained in the porous film was 0.1 μm, and the bubble point in accordance with JIS K 3832 measured by using methanol as a measuring medium was 115 kPa.

As a gas-liquid separating layer, a porous film formed of polytetrafluoroethylene (“TEMISH (registered trade name) NTF2122A-S06” available from NITTO DENKO CORPORATION) of 26.5 mm long, 27 mm wide and 0.2 mm thick was used. The contact angle to water of this porous film was about 120 degrees. The bubble point in accordance with JIS K 3832 of the porous film measured by using methanol as a measuring medium was 18 kPa.

On the intermediate layer, the gas-liquid separating layer was stacked, and boundaries of layers on the entire lateral surface were joined by an adhesive.

(5) Joining of Vaporized Fuel Plate

By etching, a vaporized fuel plate formed of SUS of 26.5 mm long, 27 mm wide and 0.2 mm thick having the shape shown in FIGS. 14A and 14B was prepared (all communication paths and connection paths are embodied by grooves (recesses)). The total aperture ratio of four pass-through ports is 63%, and the ratio between the total section area of two communication paths and the total area of the lateral surface of the vaporized fuel plate is 0.04. On the surface opposite to the surface formed with the grooves in the vaporized fuel plate, the joined body of the intermediate layer and the gas-liquid separating layer was stacked so that its gas-liquid separating layer side faced the vaporized fuel plate, and these were joined by thermal compression bonding.

(6) Joining of Flow Channel Plate

A flow channel plate formed of SUS having 26.5 mm long, 27 mm wide and 0.6 mm thick including in-cell fuel flow channel (flow channel of 1.5 mm wide and 0.4 mm deep) having the flow channel pattern shown in FIG. 11A was prepared. After stacking the flow channel plate on the intermediate layer of the joined body of vaporized fuel plate/gas-liquid separating layer/intermediate layer with a polyolefin based adhesive interposed therebetween, the joined body and the flow channel plate were joined by thermal compression bonding.

(7) Fabrication of Fuel Cell

On the vaporized fuel plate, the MEA-collecting layer laminate having moisturizing layers fabricated in the above was stacked, and they were joined by thermal compression bonding. Finally, epoxy resin was applied on end surface and cured to form a sealing layer, and thereby a fuel cell was obtained. A total of 20 fuel cells were fabricated.

(8) Fabrication of Fuel Distribution Portion

A fuel distribution portion formed of polyphenylene sulfide (PPS), having an outline shape (outline: 10 mm long, 138 mm wide and 6.0 mm high) as shown in FIG. 1 and FIG. 2, formed with the out-cell fuel flow channel as shown in FIG. 2 (one first main flow channel, a total of 10 second main flow channels 17, one third main flow channel, a total of 10 first branched flow channels 19a and a total of 10 second branched flow channels 19b), and having one inlet in the longitudinal center part of the top face was fabricated. The out-cell fuel flow channel has a width of 1.0 mm and a depth of 0.5 mm.

(9) Fabrication of Fuel Cell Stack

20 fuel cells and the fuel distribution portion were conjoined in the arrangement as shown in FIG. 1 and FIG. 2. Conjoining was conducted by disposing a double-faced tape between the fuel cells and the fuel distribution portion and fastening with a screw for preventing liquid leakage in the connection part between the in-cell fuel flow channel and the out-cell fuel flow channel.

(10) Fabrication of Fuel Cell System

The fuel tank and the liquid sending pump (micro pump) were connected by piping formed of polyether ether ketone (PEEK), and the liquid sending pump and the inlet of the fuel distribution portion contained in the fuel cell stack obtained above were connected by piping formed of polyether ether ketone (PEEK), to fabricate a fuel cell system.

### Comparative Example 1

A fuel cell stack and a fuel cell system were fabricated in a similar manner to Example 1 except that the structure of the fuel flow channel contained in the fuel cell stack was the structure of FIG. 6 (widths and depths of in-cell and out-cell fuel flow channels are as same as those in Example 1).

(Evaluation of Power Generating Characteristics)

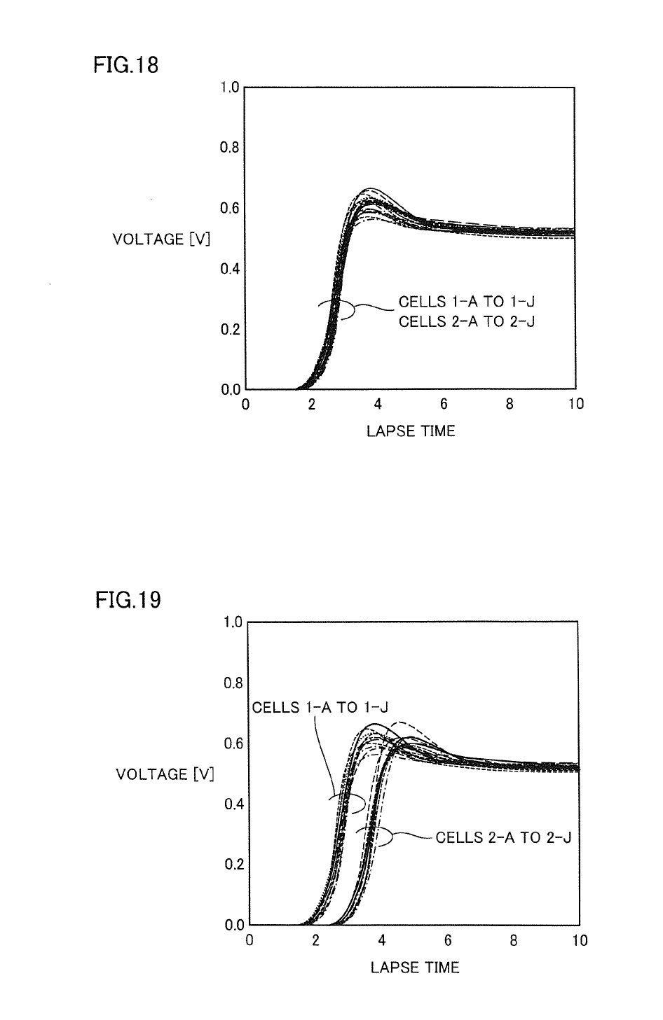

10 mol/L methanol aqueous solution was charged in a fuel tank, and supplied to the inlet by using the liquid sending pump, and power generation by the fuel cell stack was conducted. Temporal changes in voltage of each fuel cell after start of power generation in Example 1 and Comparative Example 1 are shown in FIG. 18 and FIG. 19, respectively. 10 cells (arranged on the lower side in the gravity direction in the fuel cell system) which were the first fuel cell were named 1-A, 1-B, 1-C, 1-D, 1-E, 1-F, 1-G, 1-H, 1-I and 1-J, and 10 cells (arranged on the upper side in the gravity direction in the fuel cell system) which were the second fuel cell were named 2-A, 2-B, 2-C, 2-D, 2-E, 2-F, 2-G, 2-H, 2-I and 2-J.

Both Example 1 and Comparative Example 1 showed the behavior that the voltage increased due to that the methanol aqueous solution was supplied to an empty fuel cell in the early stage of power generation, and then the voltage was stabilized at a constant voltage (open circuit voltage). However, Comparative Example 1 showed the result that rise of potential in the second fuel cell is delayed in comparison with in the first fuel cell. Referring to FIG. 6, this is attributed to the fact that the total length of second branched flow channel 19b and second in-cell fuel flow channel 23′ is longer than the total length of first branched flow channel 19a and first in-cell fuel flow channel 23. Considering the startup time of the fuel cell system, the potential rise having a different time course as shown in Comparative Example 1 is undesirable because the rise time of the system is elongated and the use's convenience is impaired, and also cell deterioration may be caused because the potential is applied in the condition that fuel has not been supplied for a certain time.

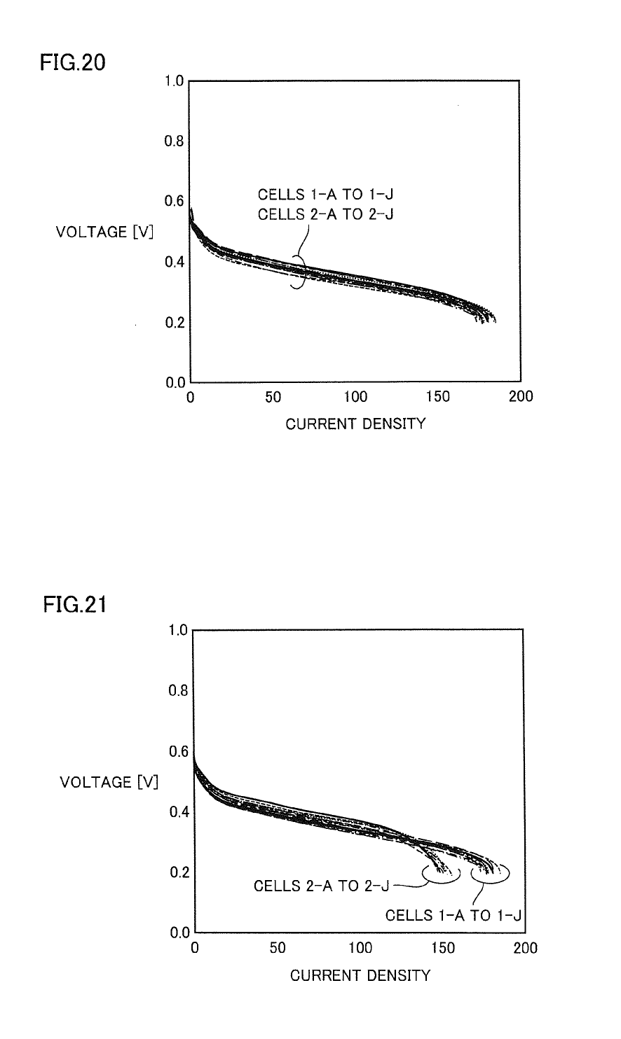

For fuel cell stacks of Example 1 and Comparative Example 1, voltage change (I-V characteristics) was measured for each fuel cell when the load current was increased stepwise by 10 mA/cm² per minute after being stabilized at the open circuit voltage. The results are shown in FIG. 20 (Example 1) and FIG. 21 (Comparative Example 1).

In Example 1, the first fuel cell and the second fuel cell showed almost the same I-V characteristics, however, in Comparative Example 1, the phenomenon that the voltage of the second fuel cell drops at a lower current density compared with the first fuel cell (material supply rate-limiting due to shortage of fuel supply) was observed. Therefore, the second fuel cell fails to exert the original characteristics of the fuel cell, and deteriorates the output of the whole fuel cell system.

The phenomenon that the I-V characteristics largely differ between the first fuel cell and the second fuel cell as described above is significantly problematic particularly when the first fuel cell and the second fuel cell are connected electrically in series. In a series circuit, since the same amount of current flows in the first fuel cell and the second fuel cell, the amount of current in the circuit is determined by the current amount that is allowed to flow in the second fuel cell having the lowest performance. Accordingly, also the first fuel cell having originally excellent potential capacity is unable to generate electric power at sufficiently high output.

### Example 2

A fuel cell stack having the configuration shown in FIG. 22 and a fuel cell system containing the same were fabricated in the following manner. The structure of fuel flow channel contained in the fuel cell stack is as shown in FIG. 23, and layer configuration of first and second fuel cells 20, 20′ is as shown in FIG. 28.

(1) Fabrication of Membrane Electrode Assembly, Stacking of Collecting Layer and Joining of Moisturizing Layer

After fabricating the membrane electrode assembly, the collecting layer was stacked to fabricate the MEA-collecting layer assembly, and then the moisturizing layer was joined in a similar manner to (1) to (3) of Example 1.

(2) Joining Between Vaporized Fuel Plate and Gas-Liquid Separating Layer

By etching, a vaporized fuel plate formed of SUS of 26.5 mm long, 27 mm wide and 0.2 mm thick having the shape shown in FIGS. 14A and 14B was prepared (all communication paths and connection paths are embodies by grooves (recesses)). The total aperture ratio of four pass-through ports is 63%, and the ratio between the total section area of two communication paths and the total area of the lateral surface of the vaporized fuel plate is 0.04. On the surface opposite to the surface formed with the grooves in the vaporized fuel plate, the gas-liquid separating layer was stacked, and joined by thermal compression bonding. As the gas-liquid separating layer, a porous film formed of polytetrafluoroethylene (“TEMISH (registered trade name) NTF2122A-S06” available from NITTO DENKO CORPORATION) of 26.5 mm long, 27 mm wide and 0.2 mm thick was used. The contact angle to water of this porous film was about 120 degrees. The bubble point in accordance with JIS K 3832 of the porous film measured by using methanol as a measuring medium was 18 kPa.

(3) Joining of Flow Channel Plate

A flow channel plate formed of SUS having 26.5 mm long, 27 mm wide and 0.6 mm thick including in-cell fuel flow channel (flow channel of 0.5 mm wide and 0.4 mm deep) having the flow channel pattern shown in FIG. 11A was prepared. After stacking the flow channel plate on the gas-liquid separating layer of the joined body of vaporized fuel plate/gas-liquid separating layer with a polyolefin based adhesive interposed therebetween, the joined body and the flow channel plate were joined by thermal compression bonding.

(4) Fabrication of Fuel Cell

On the vaporized fuel plate, the MEA-collecting layer laminate having moisturizing layers fabricated in the above was stacked, and they were joined by thermal compression bonding. Finally, epoxy resin was applied on end surface and cured to form a sealing layer, and thereby a fuel cell was obtained. A total of 20 fuel cells were fabricated.

(5) Fabrication of Fuel Distribution Portion

A fuel distribution portion formed of polyphenylene sulfide (PPS), having an outline shape (outline: 10 mm long, 138 mm wide and 6.0 mm high) as shown in FIG. 22 and FIG. 23, formed with the out-cell fuel flow channel as shown in FIG. 23 (one first main flow channel, a total of 10 second main flow channels 17, one third main flow channel, a total of 10 first branched flow channels 19a and a total of 10 second branched flow channels 19b), and having one inlet in the longitudinal center part of the top face was fabricated. The out-cell fuel flow channel has a width of 1.0 mm and a depth of 1.0 mm.

(6) Fabrication of Fuel Cell Stack

20 fuel cells and the fuel distribution portion were conjoined in the arrangement as shown in FIG. 22 and FIG. 23. Conjoining was conducted by disposing a double-faced tape between the fuel cells and the fuel distribution portion and fastening with a screw for preventing liquid leakage in the connection part between the in-cell fuel flow channel and the out-cell fuel flow channel.

(7) Fabrication of Fuel Cell System

The fuel tank and the liquid sending pump (micro pump) were connected by piping formed of polyether ether ketone (PEEK), and the liquid sending pump and the inlet of the fuel distribution portion contained in the fuel cell stack obtained above were connected by piping formed of polyether ether ketone (PEEK), to fabricate a fuel cell system.

### Comparative Example 2

A fuel cell stack and a fuel cell system were fabricated in a similar manner to Example 2 except that the width and the depth of the flow channel of the out-cell fuel flow channel (flow channel: width 1.0 mm, depth 1.0 mm) were identical to those of the in-cell fuel flow channel.

(Evaluation of Power Generating Characteristics)

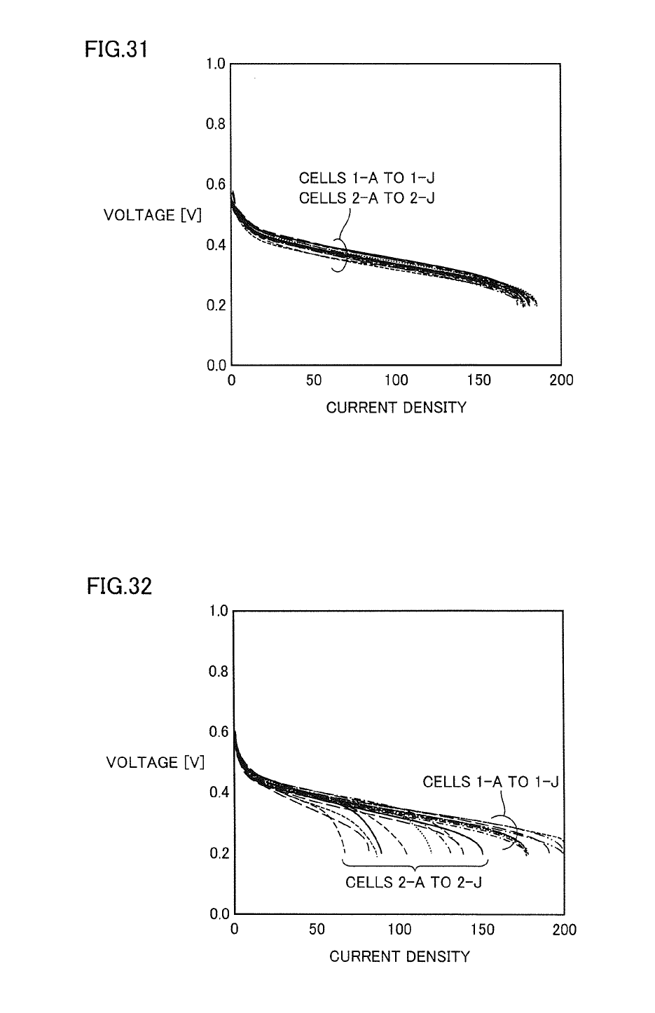

For fuel cell stacks of Example 2 and Comparative Example 2, after charging 10 mol/L methanol aqueous solution in a fuel tank, supplying it to the inlet by using the liquid sending pump, and starting power generation by the fuel cell stack, voltage change (I-V characteristics) was measured for each fuel cell when the load current was increased stepwise by 10 mA/cm² per minute. The results are shown in FIG. 31 (Example 2) and FIG. 32 (Comparative Example 2). 10 cells (arranged on the lower side in the gravity direction in the fuel cell system) which were the first fuel cell were named 1-A. 1-B, 1-C, 1-D, 1-E, 1-F, 1-G, 1-H, 1-I and 1-J, and 10 cells (arranged on the upper side in the gravity direction in the fuel cell system) which were the second fuel cell were named 2-A, 2-B, 2-C, 2-D, 2-E, 2-F, 2-G, 2-H, 2-I and 2-J.

In Example 2, the first fuel cell and the second fuel cell showed almost the same I-V characteristics. This is because in Example 2, in comparison with Comparative Example 2, the width and the depth of the flow channel of the in-cell fuel flow channel are smaller to generate pressure loss, so that after the entire out-cell fuel flow channel is filled with the liquid fuel, the liquid fuel is supplied at a uniform flow rate to each in-cell fuel flow channel.

On the contrary, in Comparative Example 2, the phenomenon that the voltage of the second fuel cell drops at a lower current density compared with the first fuel cell (material supply rate-limiting due to shortage of fuel supply) was observed. Also it was observed that both in the first fuel cell and in the second fuel cell, the I-V characteristics greatly vary between the cells. Therefore, in Comparative Example 2, the original characteristics of the fuel cell cannot be exerted, and the output of the whole fuel cell system is reduced.

The phenomenon that the I-V characteristics largely differ in each fuel cell as is in Comparative Example 2 is significantly problematic particularly when the first fuel cell and the second fuel cell are connected electrically in series. In a series circuit, since the same amount of current flows in the first fuel cell and the second fuel cell, the amount of current in the circuit is determined by the current amount that is allowed to flow in the second fuel cell having the lowest performance. Accordingly, also the first fuel cell having originally excellent potential capacity is unable to generate electric power at sufficiently high output.

What is claimed is:

1. A fuel cell stack comprising:
a first fuel cell including a first membrane electrode assembly having a first anode electrode, a first electrolyte membrane and a first cathode electrode in this order, and a first fuel supply portion arranged on the side of said first anode electrode and having a first in-cell fuel flow channel for allowing liquid fuel to communicate;
a second fuel cell arranged on a main surface of said first fuel cell, the second fuel cell including a second membrane electrode assembly having a second anode electrode, a second electrolyte membrane and a second cathode electrode in this order, and a second fuel supply portion arranged on the side of said second anode electrode and having a second in-cell fuel flow channel for allowing liquid fuel to communicate, and
a fuel distribution portion connected to said first and second fuel cells, for distributing said liquid fuel into said first and second fuel cells,
said fuel distribution portion having:
an inlet for introducing said liquid fuel, and
an out-cell fuel flow channel including a main flow channel connected to said inlet, a first branched flow channel connecting an end on the side opposite to said inlet in said main flow channel and said first in-cell fuel flow channel, and a second branched flow channel connecting said end and said second in-cell fuel flow channel,
wherein a total length of said first branched flow channel and said first in-cell fuel flow channel is substantially identical to a total length of said second branched flow channel and said second in-cell fuel flow channel.

2. The fuel cell stack according to claim 1, wherein said first and second branched flow channels include a flow channel part extending substantially perpendicularly to a main surface of said first or second fuel cell.

3. The fuel cell stack according to claim 1, wherein said first branched flow channel and said first in-cell fuel flow channel form, in their connection part, a flow channel that extends substantially perpendicularly to a main surface of said first fuel cell, and said second branched flow channel and said second in-cell fuel flow channel form, in their connection part, a flow channel that extends substantially perpendicularly to a main surface of said second fuel cell.

4. The fuel cell stack according to claim 1, wherein said first branched flow channel and said first in-cell fuel flow channel form, in their connection part, a flow channel that extends substantially parallel with a main surface of said first fuel cell, and said second branched flow channel and said second in-cell fuel flow channel form, in their connection part, a flow channel that extends substantially parallel with a main surface of said second fuel cell.

5. The fuel cell stack according to claim 1, wherein each of section areas of said first in-cell fuel flow channel, said second in-cell fuel flow channel and said out-cell fuel flow channel falls within the range of 100 μm² to 1 mm².

6. The fuel cell stack according to claim 1, wherein said first fuel cell and said second fuel cell are arranged at a distance so that the side of said first cathode electrode faces the side of said second cathode electrode.

7. The fuel cell stack according to claim 1, wherein said first fuel cell and said second fuel cell are arranged at a distance so that the side of said first cathode electrode faces the side of said second fuel supply portion, or the side of said second cathode electrode faces the side of said first fuel supply portion.

8. The fuel cell stack according to claim 1, comprising:
a first fuel cell assembly including two or more said first fuel cells arranged on the same plane,
a second fuel cell assembly arranged on a main surface of said first fuel cell assembly, said second fuel cell assembly including two or more said second fuel cells arranged on the same plane and arranged to face respective said first fuel cells, and
said fuel distribution portion connected to every said first and second fuel cell,
wherein at least regarding first fuel cell and second fuel cell facing each other, a total length of said first branched flow channel and said first in-cell fuel flow channel is substantially identical to a total length of said second branched flow channel and said second in-cell fuel flow channel.

9. The fuel cell stack according to claim 8, wherein said first fuel cell assembly includes two or more first fuel cells arranged in line, and said second fuel cell assembly includes two or more second fuel cells arranged in line.

10. The fuel cell stack according to claim 9, wherein in said first fuel cell assembly, two or more first fuel cells are arranged so that a gap is formed between neighboring two first fuel cells, and in said second fuel cell assembly, two or more second fuel cells are arranged so that a gap is formed between neighboring two second fuel cells.

11. The fuel cell stack according to claim 9, wherein said first fuel cell assembly includes two or more first fuel cells arranged in line without any gap, and said second fuel cell assembly includes two or more second fuel cells arranged in line without any gap.

12. The fuel cell stack according to claim 1, which is a direct alcohol type fuel battery.

13. A fuel cell system comprising:
a fuel cell stack according to claim 1; and
a fuel tank connected to said inlet, for accommodating said liquid fuel.

14. The fuel cell system according to claim 13, further comprising a liquid sending means for promoting flow of said liquid fuel to said inlet from said fuel tank.

15. A fuel cell stack comprising:
a first fuel cell including a first membrane electrode assembly having a first anode electrode, a first electrolyte membrane and a first cathode electrode in this order, and a first fuel supply portion arranged on the side of said first anode electrode and having a first in-cell fuel flow channel for allowing liquid fuel to communicate;
a second fuel cell arranged on a main surface of said first fuel cell, the second fuel cell including a second membrane electrode assembly having a second anode electrode, a second electrolyte membrane and a second cathode electrode in this order, and a second fuel supply portion arranged on the side of said second anode electrode and having a second in-cell fuel flow channel for allowing liquid fuel to communicate, and
a fuel distribution portion connected to said first and second fuel cells, for distributing said liquid fuel into said first and second fuel cells,
said fuel distribution portion having an inlet for introducing said liquid fuel, and an out-cell fuel flow channel connecting said inlet and said first and second in-cell fuel flow channels,
wherein a fuel flow channel composed of said first and second in-cell fuel flow channels and said out-cell fuel flow channel is so configured that pressure loss of the liquid fuel flowing into said first and second in-cell fuel flow channels from said inlet through said out-cell fuel flow channel increases at or in the vicinity of a connection part of said first and second in-cell fuel flow channels and said out-cell fuel flow channel.

16. The fuel cell stack according to claim 15, wherein at least at or in the vicinity of the connection part between said first and second in-cell fuel flow channels and said out-cell fuel flow channel, a section area of a fuel flow channel part on the side of said inlet based on the connection part or the vicinity thereof is larger than a section area of the remaining fuel flow channel part.

17. The fuel cell stack according to claim 16, wherein at least at the connection part between said first and second in-cell fuel flow channels and said out-cell fuel flow channel, a section area of said out-cell fuel flow channel is larger than section areas of said first and second in-cell fuel flow channels.

18. The fuel cell stack according to claim 16, wherein a porous body is charged in said fuel flow channel at or in the vicinity of the connection part between said first and second in-cell fuel flow channels and said out-cell fuel flow channel.

19. The fuel cell stack according to claim 15, wherein said out-cell fuel flow channel includes a main flow channel connected to said inlet, a first branched flow channel connecting an end on the side opposite to said inlet in said main flow channel and said first in-cell fuel flow channel, and a second branched flow channel connecting said end and said second in-cell fuel flow channel, and
said first and second branched flow channels include a flow channel part that extends substantially perpendicularly to a main surface of said first or second fuel cell.

20. The fuel cell stack according to claim 19, wherein said first branched flow channel and said first in-cell fuel flow channel form, in their connection part, a flow channel that extends substantially perpendicularly to a main surface of said first fuel cell, and said second branched flow channel and said second in-cell fuel flow channel form, in their connection part, a flow channel that extends substantially perpendicularly to a main surface of said second fuel cell.

21. The fuel cell stack according to claim 19, wherein said first branched flow channel and said first in-cell fuel flow channel form, in their connection part, a flow channel that extends substantially parallel with a main surface of said first fuel cell, and said second branched flow channel and said second in-cell fuel flow channel form, in their connection part, a flow channel that extends substantially parallel with a main surface of said second fuel cell.

22. The fuel cell stack according to claim 15, wherein said first fuel cell and said second fuel cell are arranged at a distance so that the side of said first cathode electrode faces the side of said second cathode electrode.

23. The fuel cell stack according to claim 15, wherein said first fuel cell and said second fuel cell are arranged at a distance so that the side of said first cathode electrode faces the side of said second fuel supply portion, or the side of said second cathode electrode faces the side of said first fuel supply portion.

24. The fuel cell stack according to claim 15, comprising:
a first fuel cell assembly including two or more said first fuel cells arranged on the same plane,
a second fuel cell assembly arranged on a main surface of said first fuel cell assembly, said second fuel cell assembly including two or more said second fuel cells arranged on the same plane and arranged to face respective said first fuel cells, and
said fuel distribution portion connected to every said first and second fuel cell.

25. The fuel cell stack according to claim 24, wherein said first fuel cell assembly includes two or more first fuel cells arranged in line, and said second fuel cell assembly includes two or more second fuel cells arranged in line.

26. The fuel cell stack according to claim 25, wherein in said first fuel cell assembly, two or more first fuel cells are arranged so that a gap is formed between neighboring two first fuel cells, and in said second fuel cell assembly, two or more second fuel cells are arranged so that a gap is formed between neighboring two second fuel cells.

27. The fuel cell stack according to claim 25, wherein said first fuel cell assembly includes two or more first fuel cells arranged in line without any gap, and said second fuel cell assembly includes two or more second fuel cells arranged in line without any gap.

28. The fuel cell stack according to claim 15, which is a direct alcohol type fuel battery.

29. A fuel cell stack composite comprising:
a first fuel cell stack which is the fuel cell stack according to claim 15; and
a second fuel cell stack arranged on a main surface of said first fuel cell stack, said second fuel cell stack being the fuel cell stack according to claim 15,
wherein an out-cell fuel flow channel of said first fuel cell stack and an out-cell fuel flow channel of said second fuel cell stack communicate with each other, and
at least in a connection part of the out-cell fuel flow channels, a section area of the out-cell fuel flow channel of said second fuel cell stack is larger than a section area of the out-cell fuel flow channel of said first fuel cell stack.

30. A fuel cell system comprising:
the fuel cell stack according to claim 15 or the fuel cell stack composite according to claim 29; and
a fuel tank connected to said fuel cell stack or fuel cell stack composite, for accommodating said liquid fuel.

31. The fuel cell system according to claim 30, further comprising a liquid sending means for promoting flow of said liquid fuel to said fuel cell stack or fuel cell stack composite from said fuel tank.
